(19) United States
(12) Patent Application Publication
(10) Pub. No.: US 2014/0052342 A1
(43) Pub. Date: Feb. 20, 2014

(54) WARNING SYSTEM FOR DETECTING INFANT SEAT BUCKLE SECUREMENT

(71) Applicant: Joseph Seibert, Cincinnati, OH (US)

(72) Inventor: Joseph Seibert, Cincinnati, OH (US)

(21) Appl. No.: 14/001,258

(22) PCT Filed: Feb. 25, 2012
(86) PCT No.: PCT/US2012/026671

§ 371 Date: Nov. 4, 2013

Related U.S. Application Data
(60) Provisional application No. 61/446,622, filed on Feb. 25, 2011.

(51) Int. Cl. B60R 22/48; B60W 50/14; B60R 22/10

(52) U.S. Cl. CPC B60R 22/48; B60R 22/105; B60W 50/14
USPC 701/45; 340/457.1

(57) ABSTRACT

A child seat-vehicle safety system for a passenger vehicle, including at least one child seat buckle signaling device, which includes a buckling detector, and a buckling detector for signaling the buckle status, and a portable controller device that attaches to the On-Board Diagnostic II (OBD-II) port of the vehicle, for detecting the status of the vehicle ignition system, receiving the buckle status signal, and generating an alarm signal in response to a predetermined condition of the ignition status and the buckle status signal. The portable controller device also can include an alarm that is responsive to the alarm signal. The invention includes a method of warning a vehicle operator that a child has been left buckled in a vehicle after the vehicle's ignition system has been turned off, including detecting the vehicle ignition status selected from “on” and “off” through the OBD-II port, receiving a buckle status signal transmitted from the child seat buckle signaling device, and generating an alarm signal when the ignition status is “off” and the buckle status signal is ‘buckled’ beyond a predetermined grace or timeout period.

### FIELD OF THE INVENTION

This invention relates to a child seat-vehicle safety system used with a child safety seat.

### BACKGROUND OF THE INVENTION

There have been a number of tragic deaths in which children have been mistakenly left in automobiles after the driver had reached his/her desired destination and left the vehicle. The deaths have usually been caused by a buildup of excessive heat or excessive cold within the vehicle during the absence of the driver. Conventional infant car seats and toddler booster seats are intended to restrain the infant or toddler during transportation within the vehicle, and are typically designed so that the infant or toddler cannot by oneself release the seat belt or restraint. Infants and small children are rapidly susceptible to hyperthermia when subjected to the elevated temperatures within an enclosed vehicle, with sometimes fatal consequences.

Current motor vehicle laws typically require that a child under a certain age be buckled into an infant seat, and that the infant seat be secured on the back seat of the motor vehicle. As such, the child is out of the sight of the vehicle operator, and possibly due to the rush of a busy day, also out of mind. When the vehicle operator leaves the car, a distraction or other diversion may cause the operator to forget that the child is still in the car, or the operator, believing that they will leave the vehicle for a short period of time, may just leave the child in the vehicle.

Dangers associated with leaving children in a parked vehicle are well documented. In particular, the temperature inside a parked vehicle in the sun rapidly increases to life threatening levels. Accordingly, a warning system for alerting the vehicle operator that the child has been left unattended would be desirable.

Modern vehicles typically have a belt sensor that is used to detect whether the seat belt buckle is buckled or unbuckled, or a weight sensor in the vehicle seat to detect an occupied seat status. However, the typical use of child restraint systems or car seats renders these obvious methods of detection useless, because when a child seat is typically installed the seat belt is semi-permanently buckled and the installation causes constant downward pressure on the seat, which causes weight sensors to constantly indicate an occupied status.

Many designs are complex and would interfere with the removal and moving and collapsing of many of the seats in use in vehicles today.

Oftentimes, the sensing of the buckled or unbuckled state is performed after the ignition is started and an indicator associated with the sensor is used to remind the vehicle operator to fasten the seat belt.

Additionally, vehicles typically only have a driver seat belt sensor and, at most, a front seat passenger seat belt; the rear seats may not have a seat belt sensor at all. The child restraint seat is typically secured to the back seat of the vehicle, such as by the vehicle seat belt. Typically, the restraint belts of the infant seat are not interconnected to any vehicle sensor.

One system for preventing children from becoming inadvertently left within a vehicle is described in U.S. Pat. Publication No. 2009/0079557, published Mar. 26, 2009 (the disclosure of which is incorporated by reference in its entirety) that describes a warning system for signaling the presence of a child in an infant seat, the system being portable, at least in part, and generating and transmitting an alarm to the vehicle operator as a result of the operator having walked away from the vehicle and the infant remaining latched in the infant seat. This patent describes a wireless apparatus, including a transmitter associated with an infant latched into an infant seat and a receiver carried by the vehicle operator. The receiver measures the strength of a signal from the transmitter and generates an alarm signal to the operator when the signal strength falls below a prescribed level, thereby indicating that a child has been left unattended in the vehicle.

Another system for preventing children from becoming inadvertently left or locked within a vehicle is described in U.S. Pats. No. 6,104,293 and 5,949,340 (the disclosures of which are incorporated by reference in their entirety) that describe an apparatus for warning when a child has been left in an infant seat and a vehicle as been turned off. The apparatus includes an occupant detection mechanism for detecting the presence of an occupant within an infant seat located within a vehicle; an ignition detection mechanism for detecting the state of the vehicle's ignition system; a control unit for generating an alarm signal when the occupant detection mechanism detects the presence of an occupant within the infant seat and the ignition detection mechanism detects that the vehicle's ignition system has been turned from an ‘on’ state to an ‘off’ state; and an alarm unit for generating an alarm in response to the alarm signal. The components of the apparatus can be located within the infant seat, within the vehicle or combined within the infant seat and the vehicle. The means for detecting the presence of an occupant in the infant seat include but are not limited to a mechanical switch, an optical detector, a heat detector, a sonar detector and a weight detector. A control unit is located within the infant seat or alternatively within the vehicle into which the infant seat is placed. An onboard computer provided in the vehicle, for example, can be utilized to perform the functions of the control unit.

U.S. Pat. No. 6,489,889, issued to Smith (the disclosure of which is incorporated by reference in its entirety), describes a system for detecting the presence of an occupant within a vehicle that has a seat belt sensor that generates a seat belt buckled signal and an ignition sensor generating an ignition-off signal. An indicator is also included in the system. An ignition sensor has an ignition switch commonly used in automotive vehicles, which receives a key that allows a lock cylinder to rotate and activate the switch. The switch has an on position and an off position generating an on signal and off signal, respectively.

US Patent Publication 2011/0025486 (the disclosure of which is incorporated by reference in its entirety) discloses a voltage detecting device that plugs into a cigarette lighter port to detect when the engine is turned off and a prompting device that asks the driver to designate that children will be traveling in the car.

Review of child accidental deaths cases due to hyperthermia in vehicles demonstrates that this usually occurs when the parent or caretaker has deviated from a usual routine with the child. For example, a different vehicle is used, or a different parent takes the child to a destination that day due to the exigencies of family and work life. A more effective system, as described below, once installed, would require no further caretaker action to achieve a ready state of protection. For example, it would not require the carrying of a particular keyfob or receiver by the caretaker. It would not require additional buckling actions by the caretaker beyond the act of buckling the child into the seat as always. It would not involve child presence sensors more likely to yield false positive and/or false negative detection states. Such a system, once installed, would also allow the frequent movement of one or more car seats among several equipped vehicles, as is typical in family and/or carpool use, without any further action by caretaker. The goal of reducing or eliminating accidental child deaths in vehicles due to hyperthermia could be more readily approached.

In view of the above, there remains a need to provide a convenient, more portable, effective system that warns when a child has been left secured into the infant seat or toddler booster seat in an unattended vehicle, particularly with the vehicle engine turned off and the doors closed, and which is convenient for use in one or several vehicles and with one or several infant seats.

### SUMMARY OF THE INVENTION

An aspect of the present invention is a child seat-vehicle safety apparatus and system that can be configured for operation within any passenger vehicle or light truck, quickly (for example, within seconds) and easily (for example, by anyone without specific skills and without requiring a tool), and can be removed from the same vehicle as quickly and easily, and moved to another vehicle as quickly and easily.

Another aspect of the present invention is a child seat-vehicle safety apparatus and system that, after the apparatus and system are initiated a first time at a first use, does not require the person using the apparatus and system to turn on or initiate the protection feature, each time that the passenger vehicle is started up and the child is buckled into the child safety seat.

A further aspect of the present invention is a portable child seat-vehicle safety system that, after an initial setup on the first use, can provide for a restraint device associated with a child safety seat within a single passenger vehicle, for multiple restraint devices child safety seats within a single passenger vehicle, and for one or more restraint devices that can be moved at will between two or more passenger vehicles.

The present invention provides a child seat-vehicle safety system for a child safety seat in a passenger vehicle, comprising: a) at least one restraint device associated with a child safety seat, the restraint device including a restraint mechanism and a buckling detector that detects the buckling status of the at least one restraint device as either buckled or unbuckled, and a buckle signal transmitter for transmitting a buckle status signal; b) a portable controller device that attaches to the On-Board Diagnostic II (OBD-II) port of the vehicle, including a means for detecting a parameter of the vehicle's ignition system, a transmission receiver for receiving the buckle status signal, and an alarm signal generator for generating an alarm signal in response to a predetermined condition of the ignition system parameter and the buckle status of the restraint device; and c) an optional alarm responsive to the alarm signal.

The invention also includes a method of warning a vehicle operator that a child has been left buckled in a child safety seat of a vehicle after the vehicle's ignition system has been turned off, the method including the steps of: providing a restraint device including a restraint mechanism; generating a buckle status signal in response to the buckling of the restraint mechanism; transmitting the buckle status signal; providing a portable controller device installed into the OBD-II port of the vehicle that detects the status of a parameter of the ignition system through the OBD-II port; detecting the status of the ignition system parameter; receiving the buckle status signal; and generating an alarm signal when the buckled status signal is ‘buckled’ and the status of the ignition system parameter changes from ‘on’ to ‘off’. The method can further include generating an alarm responsive to the alarm signal.

A further aspect of the present invention is a portable controller device that attaches to the On-Board Diagnostic II (OBD-II) port of a passenger vehicle or light truck. The OBD-II port has been a required feature on all passenger vehicles and light trucks sold in the US since Jan. 1, 1996. The controller device can include a microprocessor that interrogates the vehicle's electrical system to detect a parameter of the vehicle operation or the vehicle ignition system, to determine when the vehicle's engine is running (or when the ignition is ‘on’) and when it is not. The controller is placed into electronic communication with the pins of the OBD-II port. The ignition system parameter includes the vehicle's battery system, and in particular the voltage potential across the battery.

Another aspect of the invention is a chest clip for fastening harness straps of a child seat restraint system. The chest clip includes a restraint mechanism and a buckling detector that detects the buckling status of the restraint mechanism. The restraint mechanism includes a latch member and a buckle member securable to the latch member. The latch member includes an extending element, and the buckle member includes a body defining a cavity having a front opening, into which the latch extending element of the latch is inserted to a secured position for releasable securement of the latch member to the buckle member. The buckling detector is secured to either one of the body of the buckle member or the latch member, and includes a detector switch, a replaceable battery, and an radio frequency (RF) transmitter. The detector switch can include a lever arm that is biased by the other of the buckle member or the latch member during insertion of the latch member into the buckle member.

The present invention also provides a child seat-vehicle safety system for a child safety seat in a passenger vehicle, comprising: a) at least one restraint device associated with a child safety seat, the buckle signaling device including a restraint mechanism and a buckling detector for detecting the buckle status of the restraint mechanism as either buckled or unbuckled, and a buckle signal transmitter for transmitting a buckle status signal; b) a portable controller device that includes an interface for an electrical circuit of the vehicle that presents the voltage potential of the battery, a voltmeter for measuring the voltage potential of the battery, a transmission receiver for receiving the buckle status signal, and an alarm signal generator for generating an alarm signal in response to a predetermined condition of the battery voltage potential and the buckle status signal. The portable controller device can include an optional alarm responsive to the alarm signal.

A further aspect of the invention is a portable controller device that can transmit an alarm signal or a sequence of alarm signals. The alarm signal can also be broadcasted by the portable controller device, or by the vehicle, for receipt by a remote receiver, such as a keyfob. In an aspect of the invention, an alarm signal generator generates an alarm signal when the status of the buckle status signal is buckled and the vehicle's ignition system status changes from ‘on’ to ‘off’, immediately or for beyond a predetermined period of time.

The invention also includes a method of warning a vehicle operator that a child has been left buckled in a vehicle after the vehicle's ignition system has been turned off, the method including the steps of: a) providing at least one restraint device associated with a child safety seat, the buckle signaling device including a restraint mechanism and a buckling detector; b) detecting the buckle status of the restraint mechanism as either buckled or unbuckled, c) transmitting a buckle status signal; d) providing an on-board native controller device; (e) detecting the status of the vehicle ignition system as ‘on’ or ‘off’; f) receiving the buckled status signal; and g) and generating an alarm signal when the buckled status signal is ‘buckled’ and the status of the vehicle ignition parameter changes from ‘on’ to ‘off’.

In an aspect of the invention, a detector for receiving the vehicle ignition system status signal consists of an interface for an electrical circuit of the vehicle that presents the voltage state of the battery of the vehicle, and a voltmeter for measuring the voltage status of the battery. The interface is typically a hard-wired circuit to both the vehicle ground and to the vehicle battery voltage line.

The detector can also include a CAN interface for the CAN network of the vehicle.

In another aspect of the invention, the portable controller device and the on-board native controller device can include a microprocessor that interrogates the vehicle's ignition system. In one such aspect, the native controller device interrogates the status of the automobile's CAN network to determine if any one or more of the vehicle's operational systems that indicate that the vehicle's engine is running and is ‘on’, or is ‘off’. Such operational systems include the fuel delivery rate, the engine rpm, the engine oil pressure, and others.

The portable controller device can also include a microprocessor that is programmed with, or is provided access to, and memory for storing, the vehicle's CAN network to determine vehicle manufacture information about the vehicle, including the make, model, and year of manufacture of the vehicle. This information is compared with a database of known vehicle manufacture information that is stored in the non-volatile memory of the portable controller device, and the appropriate communication protocol for the vehicle is ascertained. The information associated with a given vehicle includes the protocol needed for the microprocessor to properly communicate with (that is, interrogate and signal) the vehicle's on-board network. The communication over the vehicle's CAN (Controller Area Network) can involve retrieval of vehicle state information, such as ignition system status. The communication can also actively manage various features of the vehicle functions.

The portable or native controller device can interrogate the status of the automobile's battery system to detect when the vehicle's engine is running and when it is not. The controller temporally can record the voltage status and can analyze the voltage hysteresis. A voltage across the battery above a first voltage level can indicate that the automobile's ignition system is on and the engine is running, because the alternator system is putting a charge differential across the battery terminals. The first voltage level is typically a voltage differential of more than 13 volts, and more typically about 13.3 volts or more. A voltage differential below a second voltage level indicates that the engine is not running, because the battery is exerting a potential and power is being drawn from the battery, for example at start-up. The second voltage level is typically less than 13 volts, and more typically about 12.6 volts or less.

The present invention also provides a child seat-vehicle safety system for a child safety seat in a passenger vehicle, comprising: a) at least one restraint device associated with the child safety seat, the restraint device including a restraint mechanism and a buckling detector that detects the buckle status of the restraint device, and a buckle signal transmitter for transmitting an encrypted buckle status signal; and b) an on-board native controller device of a vehicle that includes a detector for detecting the status of the vehicle ignition system, a transmission receiver for receiving the buckle status signal, and an alarm signal generator for generating and transmitting an alarm signal to the vehicle CAN network system in response to a predetermined condition of the vehicle ignition system status and the buckle status signal. The alarm signal communicated to the vehicle CAN network system generates the on-board alarm, wherein the on-board alarm can include an audible voice, music, or tone, a buzzer, the vehicle's car theft alarm, the vehicle ignition, the vehicle heater, the vehicle air conditioner, the vehicle power door system, the vehicle power window system, the vehicle sound system or radio, the vehicle horn, the vehicle light systems including the compartment lights, headlights, warning lights, and taillights, and the vehicle wireless, cellular or satellite communication system.

Another aspect of the present invention is a method and means for interrogating a rectified direct current as a vehicle ignition state. The method and means includes sampling the voltage potential of a rectified direct current (DC) circuit, detecting pulses or ripples in the voltage sample of the DC circuit, and comparing the amplitude of the pulses or ripples to battery direct current, or a predetermined voltage amplitude, above which the DC signal is determined to be rectified DC.

Another aspect of the invention is an original equipment manufacturer (OEM) child safety seat that incorporates a restraint device that includes a restraint mechanism and a buckling detector that transmits a buckle status signal.

Another aspect of the invention is the use of unique identification codes for each restraint device of an equipped child safety seat, with appropriate recognition and tracking of said seats by the portable or native controller device, such that false positive alarms will not occur due to proximity to another vehicle using the same or similar system.

Another aspect of the invention is the ability for a single unique equipped seat or multiple such seats to be ‘learned’ and recognized by multiple portable controller devices, such that, for example, within a family or carpool, a seat could be moved from one system-equipped vehicle to another system-equipped vehicle freely without regard for ‘re-learning’ the seat by the system, once first ‘learned’ and recognized by each given portable controller device. This allows the safety feature to be always available without further action by a possibly distracted parent or caregiver when moving seat(s) between appropriately equipped family or carpool vehicles that have previously ‘learned’ a given unique seat(s).

Another aspect of the invention is the ability for the portable controller device to be moved from one vehicle to another, for example, when taken on vacation for use within a rental car, or for use by a rental car agency fleet, yet still retain in nonvolatile memory the ‘learned’ seats. A parent or caregiver can unplug the portable controller device at home, install it in seconds in a rental car, and use it with the family's equipped child safety seat(s) previously learned, without further action required while on vacation, then return home and return the portable controller to the original vehicle, all the while enjoying the safety granted by the system and requiring no repeat ‘learning’ of the car seat(s) used.

Another aspect of the invention is the ability of the portable controller device to respond to an unexpected unbuckled state while the vehicle ignition system is on, and possibly in motion, by providing an appropriate alarm to the operator of the vehicle.

Another aspect of the invention is the ability of the restraint device to track voltage potential across the vehicle battery in the restraint device upon each use, and inform the user via a predetermined audible and/or visual signal if the battery of the restraint device needs to be replaced so that the integrity and function of the safety system can be ensured.

### BRIEF DESCRIPTION OF THE DRAWINGS

FIG. 1 illustrates child seat-vehicle safety apparatus and system of the present invention employed in a passenger vehicle, including a restraint device associated with the child safety seat, and a portable controller device that attaches to the On-Board Diagnostic II (OBD-II) port of the vehicle.

FIG. 2 illustrates the child safety seat that incorporates one or more restraint device of the present invention.

FIG. 3 illustrates the restraint device prior to buckling.

FIG. 4 illustrates the restraint device after buckling.

FIG. 5 illustrates an alternative embodiment of the restraint device after buckling.

FIG. 6A-6C illustrate the portable controller device of the present invention with a portion of the housing removed to reveal the microprocessor, buckle signal transmitter, and buckle status processor and other components. FIG. A is a front perspective view, FIG. 6B is a rear view, and FIG. 6C is a partial cut-away view showing the PCB.

FIG. 6D shows the portable controller device prototype of the invention.

FIGS. 7A-7D illustrate a power and control circuit of the restraint device for powering on, signaling, and powering off the device during a buckling and unbuckling sequence.

FIG. 8 shows a block diagram for a portable controller device that plugs into the OBD-II port, including components and microprocessor pin requirements.

FIGS. 9A and 9B illustrate an alternative restraint device. FIG. 9A shows a restraint device as a chest clip having a latch member and a buckle member. FIG. 9B shows a sectional view of the chest clip of FIG. 9A.

FIGS. 9C and 9D show the front and rear of a child restraint device prototype of the invention.

FIGS. 10A-10D illustrate the operation of the chest clip of FIG. 9A. FIG. 10A shows the latch and buckle members of the chest clip prior to buckling. FIG. 10B shows the inserting of the latch into the buckle of the chest clip. FIG. 10C shows the latch secured to the buckle of the chest clip. FIG. 10D shows the disengaging of the latch from the buckle of the chest clip.

FIGS. 11A-11B illustrate an alternative embodiment of the chest clip.

FIG. 12 shows a logic diagram of the controller device upon the buckling of the latch into the buckle of the restraint device.

FIG. 13 shows a logic diagram of notifications made by the controller device when the vehicle ignition is turned ‘off’ and in determining an active seat.

FIG. 14 shows a logic diagram of the controller device upon the unbuckling of the latch into the buckle of the restraint device.

FIG. 15 illustrates a rectified DC signal.

### DETAILED DESCRIPTION OF THE INVENTION

### Definitions

As used herein, a child safety seat is a dedicated or combination child seat, a booster seat, a convertible car seat or other similar seat for transporting a baby, infant, toddler or child in a vehicle.

As used herein, a buckle is the part of a restraint mechanism of the child safety seat or a chest clip, and is associated with one or more belt webbing straps, A latch is typically manually secured to the buckle by a parent or caregiver. The buckle typically can include a release button, typically though not necessarily colored red, for releasing the latch.

As used herein, the latch is a part of the restraint mechanism that slides into the buckle and mechanically engages the buckle, and is also associated with one or more belt webbing straps or retaining elements.

The system of the present invention includes a device for detecting the buckling and unbuckling of a restraint device of a child safety seat, and one or a variety of means for detecting the status of the vehicle ignition system. The means can include a portable controller device that interacts with the CAN network or other vehicle network to detect engine operation parameters, such as RPM, or the vehicle ignition state.

It can be readily understood that the logical functions of the portable controller device could, in future vehicles, also be implemented directly by a vehicle manufacturer through the addition or modification of vehicle onboard controller device or devices. For example, a vehicle manufacturer could modify current vehicle onboard processor software and use the vehicle's remote keyless entry (RKE) antenna to duplicate the functionality of the portable onboard controller. The description of the portable controller device's logical functions are applicable to a child seat-vehicle safety system of the present invention that includes an integrated vehicle hardware and software.

The portable device controller may interact with the CAN network or other vehicle network through the use of software or interpreter chips or both. The portable controller device can include an interface that plugs into the OBD-II port, and a housing that contains a detecting device for detecting a parameter of the vehicle ignition system, a transmission receiver, and an alarm signal generator. The alarm signal generator can include the alarm, or can communicate with the vehicle to generate the alarm, wherein the alarm can include an audible voice, music, or tone, a buzzer, the vehicle's car theft alarm, the vehicle ignition, the vehicle heater, the vehicle air conditioner, the vehicle power door system, the vehicle power window system, the vehicle sound system or radio, the vehicle horn, the vehicle light systems including the compartment lights, headlights, warning lights, and taillights, and the vehicle wireless, cellular or satellite communication system. The buckling detector can be integral with, or separate from, the restraint mechanism associated with the child safety seat. The buckle status signal is typically a wireless signal, and can include a radio frequency (RF) signal that contains at least the restraint device identification information.

The alarm signal generator of the portable controller device can generate the alarm signal when the status of the buckle status signal is buckled and the status of the vehicle ignition system is ‘off’ for beyond a predetermined time period. The alarm then responds to the alarm signal after a second predetermined time period. The status of the vehicle ignition system can include the battery voltage potential, the voltage signal quality of the rectified DC, and an engine operation parameter. The buckle status signal can be a radio frequency signal, typically broadcasted in a range between 400-900 MHz, for example, 433 MHz, that includes an encryption code, a unique identity (ID) code for the buckling detector, a “buckled” and/or “unbuckled” signal code, and optionally a battery voltage check code, an ambient temperature check code, and a CRC code.

The interface of the portable controller device can include a plug for insertion into a standard 12-V cigarette lighter socket or 12-V auxiliary power outlet socket of the vehicle, in accordance with ANSI/SAE J563 specification. An interface can also include a socket for insertion into a 12-V light bulb socket of the vehicle. The alarm signal generator can include an on-board alarm that can include an audible voice, music, or tone, a buzzer, and a light source.

The portable controller device can temporally record or detect the voltage status and analyze the voltage potential hysteresis. A voltage potential across the battery above a first voltage level can indicate that the vehicle ignition system is ‘on’ and the engine is running, because the alternator system is putting a charge differential across the battery terminals. The first voltage level is typically a voltage potential of more than 13 volts, and more typically about 13.3 volts or more. A voltage potential below a second voltage level indicates that the engine is not running, because the battery is exerting a potential and power is being drawn from the battery, for example at start-up. The second voltage level is typically less than 13 volts, and more typically about 12.6 volts or less.

The portable controller device can also temporally detect the voltage signal of the direct current (DC) circuit to determine if the DC current is battery-generated DC or rectified DC by detecting ripples in the voltage amplitude that result when AC current is rectified.

The portable controller device can also temporally detect other engine operation parameters through the vehicle CAN. Engine operation parameters can include, but are not limited to, engine revolutions (RPM), engine oil pressure, the fuel delivery rate, and others.

The portable controller device can also include a microprocessor that includes software in non-volatile memory that interrogates the vehicle via the OBD-II port to determine vehicle manufacture information about the vehicle, including the make, model, and year of manufacture of the vehicle. This information is compared with a database of known vehicle manufacture information that is stored in the non-volatile memory of the portable controller device, and the appropriate communication protocol for the vehicle is ascertained. The information associated with a given vehicle includes the protocol needed for the microprocessor to properly communicate with (that is, interrogate and signal) the vehicle's on-board network. The communication over the vehicle's CAN (Controller Area Network) can involve retrieval of vehicle state information, such as ignition system status. The communication can also actively manage various features of the vehicle functions.

The portable controller device can include an updating port as an interface for updating known vehicle manufacture information or software stored within the non-volatile memory of the portable controller device as such information becomes available or as new model years come to market. A typical updating port can include a mini-USB port, a micro-USB port, a RS-232 port, or a firewire port.

The alarm signal can be transmitted through the OBD-II port, to initiate an alarm signal-responding feature of the vehicle based upon the vehicle model specifications stored within the controller device. Examples of an alarm signal-responding feature of the passenger vehicle can include an audible voice, music, or tone, a buzzer, the vehicle's car theft alarm, the vehicle ignition, the vehicle heater, the vehicle air conditioner, the vehicle power door system, the vehicle power window system, the vehicle sound system or radio, the vehicle horn, the vehicle light systems including the compartment lights, headlights, warning lights, and taillights, and the vehicle wireless, cellular or satellite communication system, such as On-Star™.

It can be clearly seen that in the case of an onboard or native controller integrated with the vehicle as manufactured, as compared to the above described portable OBD controller, the alarm signal may likewise be generated by commands to the vehicle's various systems via interaction with the vehicle network (for example, the vehicle CAN network).

The invention includes a method of warning a vehicle operator that a child has been left buckled in a vehicle after the vehicle's ignition system has been turned off. The steps of the method comprise: providing a child safety seat including a restraint device that includes a restraint mechanism, generating a buckle status signal in response to the buckling of the restraint mechanism into the buckle, transmitting the buckle status signal, providing a portable controller device installed into the OBD-II port of the vehicle that detects the status of the vehicle ignition system through the OBD-II port as ‘on’ or ‘off’; detecting the vehicle ignition status, receiving the fastened buckled status signal, and generating an alarm signal when the ignition status changes from ‘on’ to ‘off’. The method further includes generating an alarm responsive to the alarm signal.

The invention includes a logical path to achieve the same end as the above described portable OBD controller through modification of, or addition to, a vehicle manufacturer's onboard processors(s) and antenna(e).

The invention includes a child safety seat-vehicle safety system that can provide for a child safety seat within a single passenger vehicle, for a plurality of child safety seats within a single vehicle, for at least one child safety seat that can be moved between two or more passenger vehicles, and for a plurality of child safety seats that can be moved between two or more passenger vehicles.

The child-vehicle safety system for a single passenger vehicle includes at least one child seat buckle signaling device, and a portable controller device connected to the OBD-II port of such vehicle, or a vehicle-integrated onboard controller device providing the same functionality. This system provides that each of the child seat buckle signaling devices is associated with a child safety seat, and employs a buckle signaling device that broadcasts a preselected and unique buckle status signal. The buckle status signal can be automatically generated and selected by the child seat-vehicle safety system, or can be selected from a plurality of fixed signals. The buckle status signal can be identified as unique by the use of device-unique identification (ID) information conveyed within the RF message signal SS. When two or more child safety seats, with the child seat buckle signaling devices, are employed in the vehicle, the system thus provides for establishing separate and distinct buckle status signals between the portable controller device and each child seat buckle signaling device. When one or more than one child safety seats are employed in two or more different vehicles, the user can move the portable controller device from one vehicle to the next, or can use a separate portable controller device in each vehicle, wherein each separate portable controller device can be programmed to communicate independently with any one or all of the child safety seats. This allows the user the flexibility and convenience of moving a child safety seat with the child seat buckle signaling device between vehicles, without the need to re-initiate or re-install the system components.

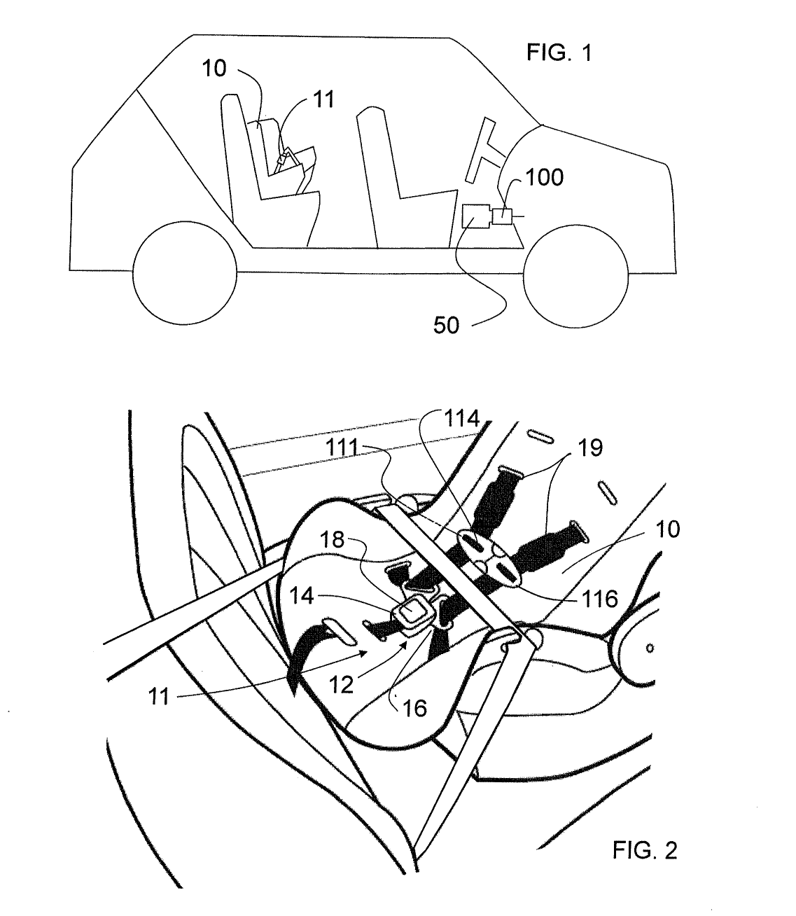

FIG. 1 shows a system and the component devices for warning an adult driver, guardian or caretaker of a child that the child safety seat remains buckled, with the child still buckled into the seat, after the ignition of the vehicle has been turned off. The system components include a child seat buckle signaling device 11, which is either integral with or retrofitted to a child safety seat 10, and a portable controller device 50 that plugs into the OBD-II port 100 of the vehicle. The portable controller device 50 detects the ignition status of the vehicle and the buckle status of the child safety seat buckle, and generates an alarm signal when the ignition is ‘off’ and the child buckle remains ‘buckled’ beyond a predetermined timeout period. The buckle signaling device 11 includes a buckling detector for detecting the buckling, and the unbuckling, of a latch into the buckle, a buckle status processor, and buckle status signal transmitter for transmitting a wireless signal when the status of the buckling changes from unbuckled to buckled, and buckled to unbuckled. The portable controller device 50 is configured, or configurable, to detect and identify the vehicle make, model and year of manufacture, and can select from an alarm condition consistent with the functional features of the vehicle. The portable controller device 50 is also configured to wirelessly receive the buckle status of the child safety seat buckle. The portable controller device 50 and the buckle signaling device 11 are also configured for coded pairing and controlling for effective wireless transmission and receipt of the buckle status, using a minimum of power.

### The Child Buckle Detector:

a) Lap Buckle

A child safety seat according to the present invention is shown in FIGS. 2-5. The child safety seat 10 is illustrated as a five-point restraint system, with an integral child seat buckle signaling device. The integral buckle signaling device is designed and manufactured as a component of the child safety seat, including a component of the securing buckle. As described herein after, the child seat buckle signaling device can be a separate device from an originally-manufactured child safety seat, such as a chest clip that is design to secure restraint straps to one another.

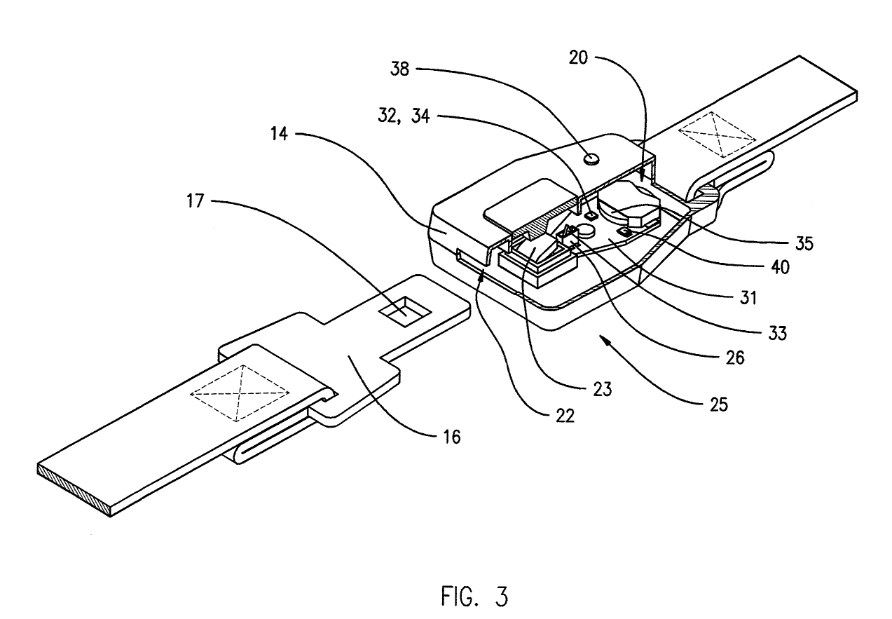

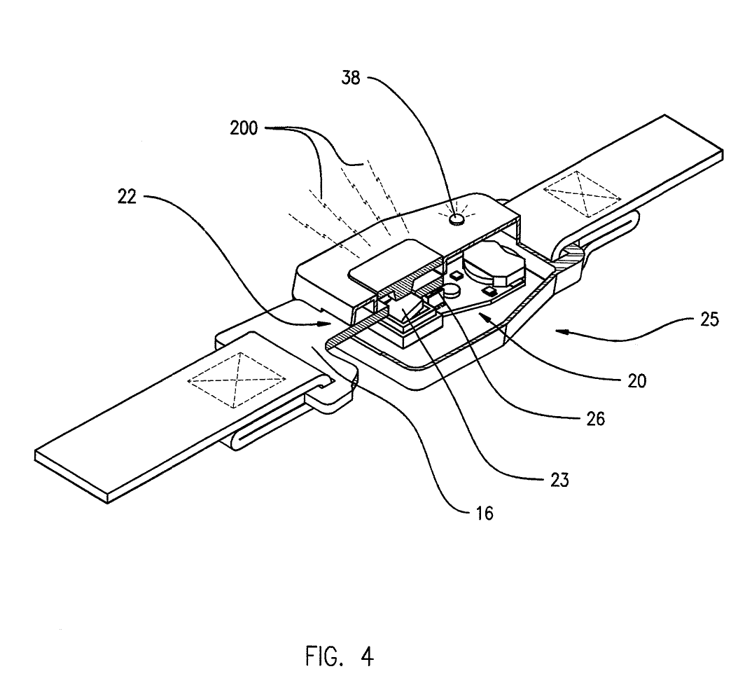

FIG. 3 shows an embodiment of signaling restraint device 11 that includes a restraint mechanism 12, a buckling detector 25, a buckle status processor 20, and a buckle signal transmitter 32. The lap restraint mechanism 12 includes a lap buckle 14 that includes a release button 18, and a latch, illustrated as a latchplate 16. The child safety seat also employs a plurality of interconnecting buckle straps including chest straps 19. The straps are made from suitable webbing and buckles which are well known and commercially available.

FIG. 3 also shows a restraint device 111 as a chest restraint mechanism 112 that can include a two-or-more-part chest clip with male and female latching components. The chest clip restraint mechanism 112 includes a chest buckle 114 and a chest latch 116, which inserts into and secures releasably to the chest buckle 114.

The child seat buckle assembly can include a restraint mechanism that is positioned on the child seat in other positions to secure other areas of the child's body, such as a waist buckle assembly.

As shown in FIGS. 3-5, the lap buckle 14 includes a buckling detector 25 for detecting the status of the restraint mechanism 12 as either ‘latched’ or ‘buckled’ when the latchplate 16 is inserted and fastened into the lap buckle 14, or as ‘unlatched’ or ‘unbuckled’ when the latchplate 16 is not inserted into and fastened into the lap buckle 14, or as when the latchplate 16 has been released from the lap buckle 14 by depressing the release button 18. As shown in FIG. 3, the latchplate 16 has an opening 17 for engaging a spring-biased clip 23 disposed within the latch channel 22. To secure the latchplate 16 to the lap buckle 14, the leading edge of the latchplate 16 is inserted and advanced into the latch channel 22, first to depress the spring-biased clip 23, and then to capture the clip 23 within the opening 17, as shown in FIG. 4.

The buckling detector 25 can include a mechanical, electro-mechanical, magnetic, optical, or Hall effect switch, or other means for detecting the buckling of the latchplate 16 into the buckle 14.

As illustrated in FIGS. 3 and 4, the buckling detector 25 is shown as an electro-mechanical switch 26 that detects the buckle status of the restraint mechanism 12. The switch 26 is mounted on and connected to a printed circuit board (PCB) 31, and has a switch lever 33 biased to a neutral (no electrical contact) central position. As the latchplate 16 advances into and captures the clip 23, to ‘buckle’ the latchplate 16 to the buckle 14 as shown in FIG. 4, the latchplate 16 passes over the switch 26 and toggles the switch lever 33 to a first or single throw position, closing a circuit in the switch. The switch lever 33 remains in the first or single throw position as long as the latchplate 16 remains buckled. The switch 26 is connected electrically through the printed circuit board (PCB) 31 to the buckle status processor 20.

A buckling detector 25 can be embodied by a wide variety of devices that communicate the buckling of the latchplate to the buckle. For example the buckling detector 25 can include two electrically-conductive contacts, each wired to the PCB, that are disposed on opposite sides of the channel and that contact the sides of the inserted metallic latchplate, such that the latchplate itself conducts current between the two contacts to complete the buckling circuit.

The buckle status processor 20 includes a buckle signal transmitter 32, shown as RF transmitter 32, to transmit or broadcast the buckle status signal, and the power source 35, such as a coin-type battery. The RF transmitter 32 includes an antenna 34 to improve the broadcasting of the buckle status signal 200. The buckle status signal 200 is typically a signal of predetermined or pre-selected strength and frequency (typically, though not necessarily, between 400-900 megahertz). The buckle status processor 20 broadcasts or sends a ‘buckled’ status signal (or, buckled signal) whenever the status of the restraint mechanism 12 is or becomes ‘buckled’, and in the illustrated figures, when the switch lever is in and remains in the first or single throw position. The buckle status processor 20 can optionally broadcast an ‘unbuckled’ status signal (or, unbuckled signal) whenever the status of the restraint mechanism is or becomes ‘unbuckled’.

The buckle status processor 20 may optionally broadcast recurrent ‘buckled’ messages after first buckled at predefined intervals until unbuckled. In either case the receipt of the signal(s), or the failure to receive an expected signal, is logically interpreted by the portable OBD controller device (or native, onboard controller device) and the status of the seat is acted upon accordingly. Each buckled or unbuckled status signal 200 is typically broadcast a number of times, though typically only for a time sufficient to allow the portable controller device 50 to receive and register the buckle status signal.

The buckle status processor 20 also includes a microprocessor 40 for controlling and directing the power source 35, for formulating the buckle status signal, and communicating with and powering the transmission of the buckle status signal, and to provide alert signals to the user related to the buckle status of the latch 16 into the buckle 14.

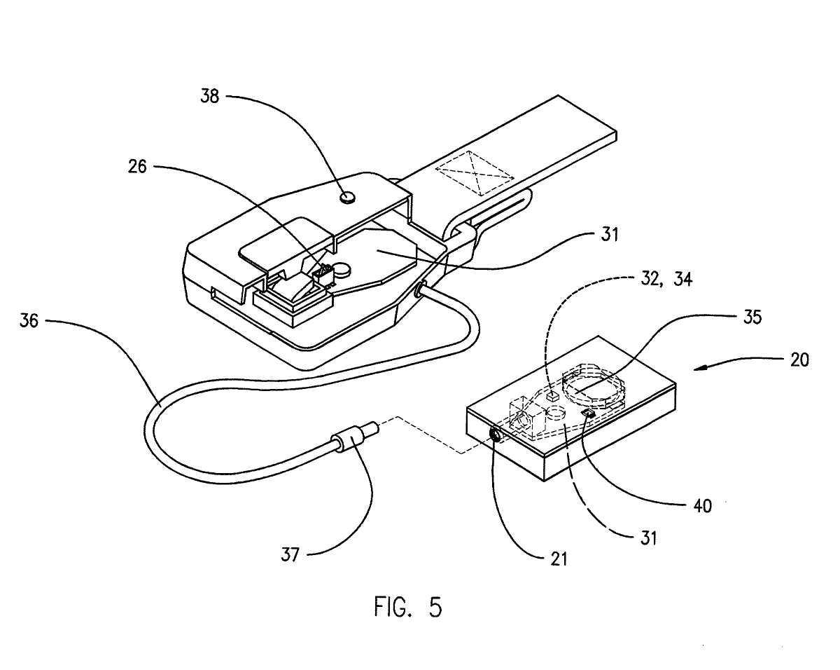

The buckle status processor 20 can also be a separate device unit from the lap buckle 14, as illustrated in FIG. 5. In this illustrated embodiment, the buckling detector 25 in the lap buckle 14 communicates with a separate buckle status processor 20b unit, through a wired connection 36 and input plug 37.

Another embodiment of a buckling detector is a magnetic switch, as described in U.S. Pat. No. 6,357,091 to Devereaux, the disclosure of which is incorporated by reference in its entirety.

Another embodiment of a buckling detector includes use of the latchplate and the buckle as terminal ends, with each of the latchplate and the buckle (comprised of electrically-conductive metallic components) connected by wiring to the circuit board of the buckle status processor, as described above. The connection wiring can be laced or woven into the securing straps of the child safety seat to the buckle status processor.

The restraint device can also be a separate device that associates with the child safety seat, and which is connected between the latchplate and the buckle of the child safety seat, and which includes a buckling detector, the buckle status processor, and the buckle status signaling transmitter. An example of a buckle and latchplate device useful in making a separate buckle signaling device is illustrated in U.S. Pat. No. 6,922,154, the disclosure of which is incorporated by reference in its entirety, which shows a seat belt interlock device (art element 10) that is connected between the buckle (art element 90) and the latchplate (art element 80) of a conventional child safety seat (art element 60).

The restraint device 11 is preferably a self-powered device that does not rely upon power from the vehicle's electric system. Typically an on-board battery is used as the sole source of power. A 3-volt nickel-cadmium battery is typically sufficient to provide power to the restraint device for several years. To minimize power requirements, the seat buckle status processor 20 can include circuitry and controls that minimize power consumption except at the moment when the child seat buckle assembly 12 is ‘buckled’ from an unbuckled state, or is ‘unbuckled’ from a buckled state, or can transmit a ‘buckled’ signal intermittently.

It can be readily understood that the failure to receive a ‘buckled’ message from a previously recognized child seat restraint device at the expiration of an expected interval can serve as an alternative means of inferring an ‘unbuckled’ status for a given seat, carrying the same logical meaning as the receipt of an ‘unbuckled’ signal. The decision to employ one method over the other for communicating seat status to the portable OBD or onboard controller device may vary from seat to seat, taking into account seat buckle or clip geometry and switch functional reliability among other factors. The functional outcome remains the same.

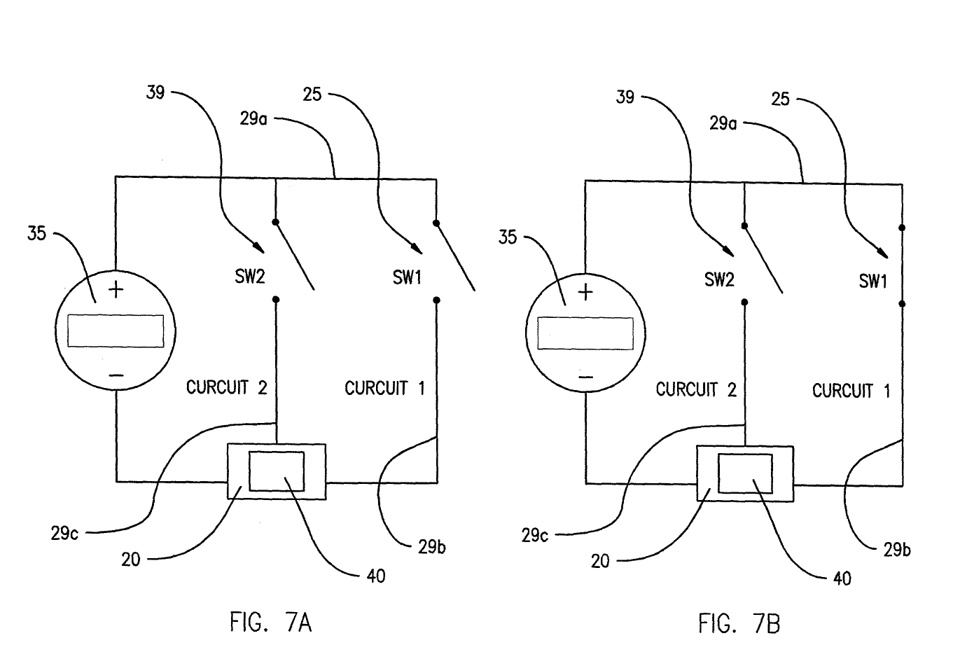

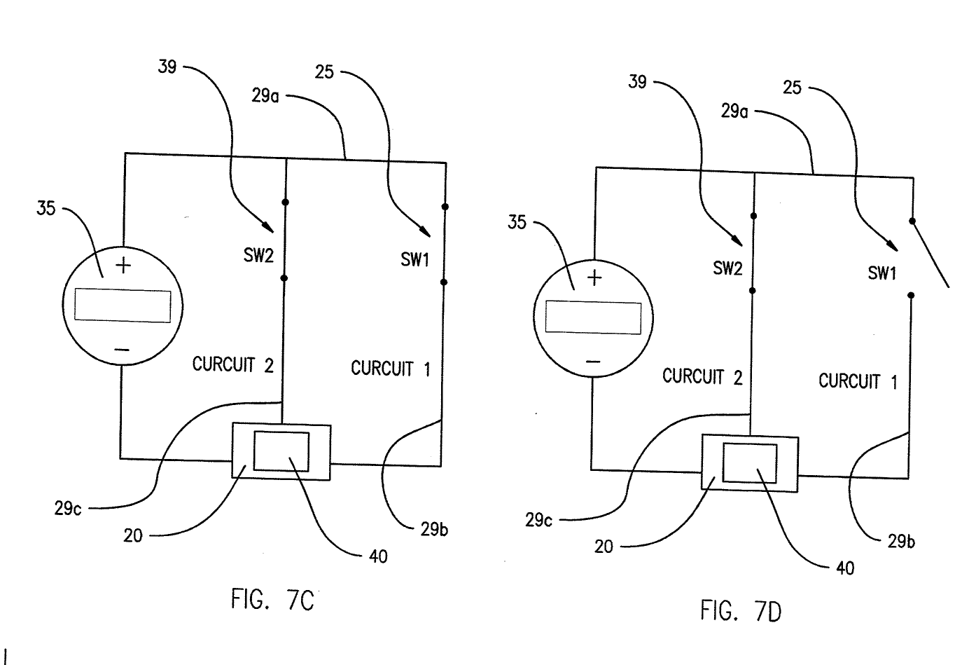

A simple example of the logic of such a circuit is shown in FIGS. 7A-7D, which together with FIGS. 3 and 4, show the restraint device 11 having battery 35 connected at its ‘+’ terminus via wiring 29a to a single-throw buckle switch 25 (SW1 in FIG. 7A) and to the buckle status processor 20 that includes microprocessor 40. When the buckle assembly is unbuckled as shown in FIG. 3 and FIG. 7A, the microprocessor 40 is unpowered, and no battery drain occurs.

The illustrated circuit describes a buckling detector that uses a single throw switch to transmit both a ‘buckled’ signal and a distinct ‘unbuckled’ signal when the restraint mechanism is buckled and unbuckled, respectively. As shown in FIG. 4 and FIGS. 7B and 7C, the buckling of the latchplate 16 to the buckle 14 engages switch 26 (SW1), which delivers power to the microprocessor 40 via Circuit 1, wiring 29b. Microprocessor 40 powers up and adopts a ‘buckled’ mode. The microprocessor 40 closes a switch 39 (not shown in FIG. 4, SW2 in FIG. 7B) that connects to wiring 29c to deliver power directly from battery 35 to the microprocessor 40 via Circuit 2. Circuit 1 (through line 29b) now serves as a signaling circuit, to signal the microprocessor 40 if the latchplate 16 is unbuckled from the buckle 14. The circuitry can include a means for preventing a temporary or ‘bounce’ signal, such as a capacitor (not shown), to prevent an ‘unbuckled’ state in case the switch 26 is intermittently and temporarily opened as a result of bouncing or jostling during the ordinary course of use, even though the buckle remains latched.

The microprocessor 40 also instructs the buckle signal transmitter 32 to transmit digitally a unique identification code assigned to the restraint device 11, and a ‘buckled’ or ‘unbuckled’ status signal over an antennae 34 for a brief period of time, for example 300-1000 msec, at a preselected frequency. Since continuous transmission of the identification code and status signal can consume a higher level of power, the transmission interval is limited to the minimum amount of time that ensures that a transmission of the unique identification code and buckle status signal 200 will be received by the portable controller device 50. The microprocessor 40 also optionally closes a circuit to power on (briefly or continuously) a light source 38 (such as a light emitting diode (LED)) or other audible signal that notifies the parent or guardian that the latchplate has engaged the buckle, and is ‘buckled’.

As shown in FIG. 7D, when the latchplate 16 is released from the buckle 14, the switch 26 (SW1) is opened, which the microprocessor 40 detects as an unbuckling and enters an ‘unbuckled’ mode. The microprocessor 40 remains powered upon first entering ‘unbuckled’ mode through Circuit 2 (line 29c) for an amount of time sufficient to transmit an ‘unbuckled’ signal through buckle signal transmitter 32. The microprocessor 40 then opens the switch 39 (SW2) that connects to wiring 29c, thereby cutting off direct power from battery 35 to itself, returning the circuit to FIG. 7A.

The cycle repeats when the latchplate 16 and buckle 14 are reconnected.

b) Chest Clip

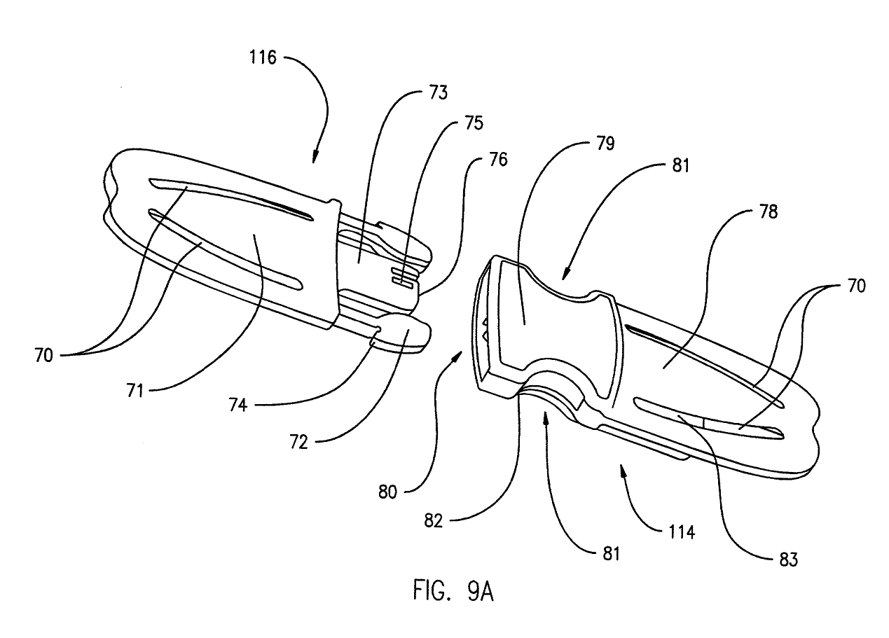

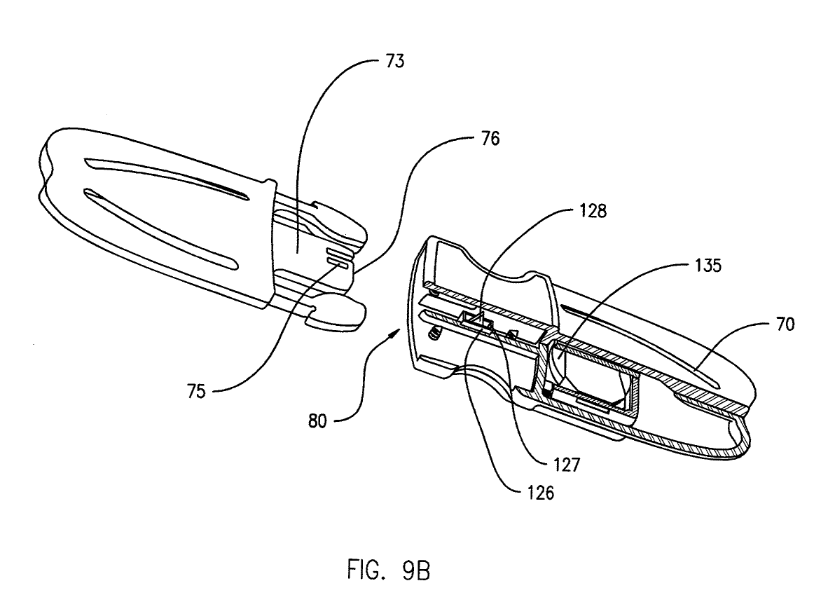

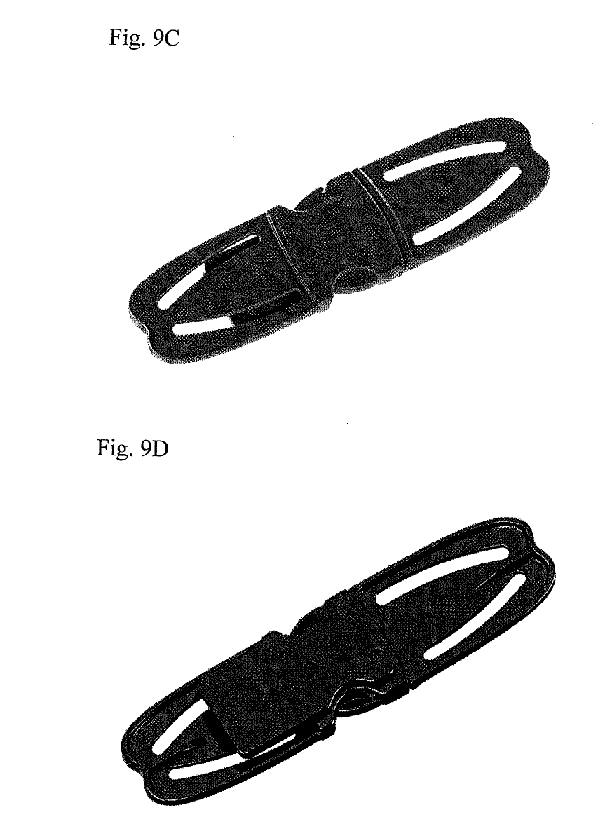

Another embodiment of child buckle assembly is illustrated in FIGS. 9A and 9B as a chest clip restraint device 111 that includes a restraint mechanism for position and securing shoulder or harness straps in position. The chest mechanism 112 includes a latch member 116 and a buckle member 114 securable to the latch member. Both the latch member 116 and the buckle member 114 have slots 70 for the harness straps 19 (as shown in FIG. 2). The latch member 116 includes a base portion 71 having the webbing slots 70, a pair of resilient arms 72 extending from the base portion 71, and at least one extending element, shown as an alignment arm 73 disposed between the two resilient arms 72. Each resilient arm 72 includes a distal end that includes an outwardly lateral protrusion 74.

The buckle member 114 includes a base portion 78 having the webbing slots 70, a body portion 79 defining a cavity having a front opening 80, and pair of openings 81 along each side 84, each side 84 including a shoulder 82 that defines an edge of the side opening 81. The buckle member 114 also includes a buckling detector 125. The latch member 116 can be secured to the buckle member 114 by inserting the two resilient arms 72 and the alignment arm 73 through the front opening 80 and into the cavity of the buckle member 114 until the distal ends of the resilient arms 72 extending into the side openings 81, and the lateral protrusion 74 on the distal ends of the resilient arms 72 extend beyond (that is, clear past) the shoulders 82. During insertion, shoulders 82 force the resilient arms 72 toward one another, so that when the lateral protrusion 74 clear the shoulders 82, the resilient arms 72 bias outwardly, securing the latch member 116 to the buckle member 114 in a ‘buckled’ condition. To release the latch member from the buckle member, the distal ends of the resilient arms 72 are forced by manipulation inwardly toward one another so that the latch member 116 can be pulled and withdrawn from the body 79 of the buckle member 114.

The buckling detector 125 is secured to the body 79 of the buckle member 114, and includes a two-way (2W) detector switch 126, a battery 135, and an RF transmitter 132 secured to a printed circuit board (PCB) 83 in electronic communication with the toggling 2W switch 126 and powered by the battery 135, as well as a microprocessor for monitoring and control of the RF transmission. The microprocessor can be a stand-alone device or incorporated into the switch or RF transmitter devices. The detector switch 126 includes a frame 127 and a lever arm 128 that extend through the body 79 in a fixed position within the cavity of the buckle member 114, and is specified and positioned to ensure that the lever 128 extends into the cavity a distance sufficient for engagement with the alignment arm 73 when the latch is inserted into the buckle.

In an embodiment, the detector switch 126 is of a single pole, double throw (SPDT) type, with a default neutral position which is an open circuit (SPCO). At least one extending element, illustrated as the alignment arm 73, has a slot opening 75 formed therein, illustrated in a lateral surface of the arm. The detector switch 126 is positioned on the buckle member 114 so that the lever 128 registers with the slot opening 75 of the alignment arm with the latch member 116 in the secured position. Although the slot opening is shown as a rectangular opening passing the entire thickness of the lateral surface of the alignment arm, the slot opening can be any shape including circular or oval, and can be formed only partially through the thickness of the alignment arm, provided that the lever arm of the switch freely rests within the slot opening when in the secured position. As the latch member is being inserted into the buckle member to the secured position, the lever 128 toggles to the first position from the neutral position. The RF transmitter 132 of the buckling detector sends a buckled signal when the lever arm toggles to the first position during insertion of the latch member into the buckle member. After the latch member arrives at and is secured in the secured position, the lever arm returns to the center neutral position within the slot opening.

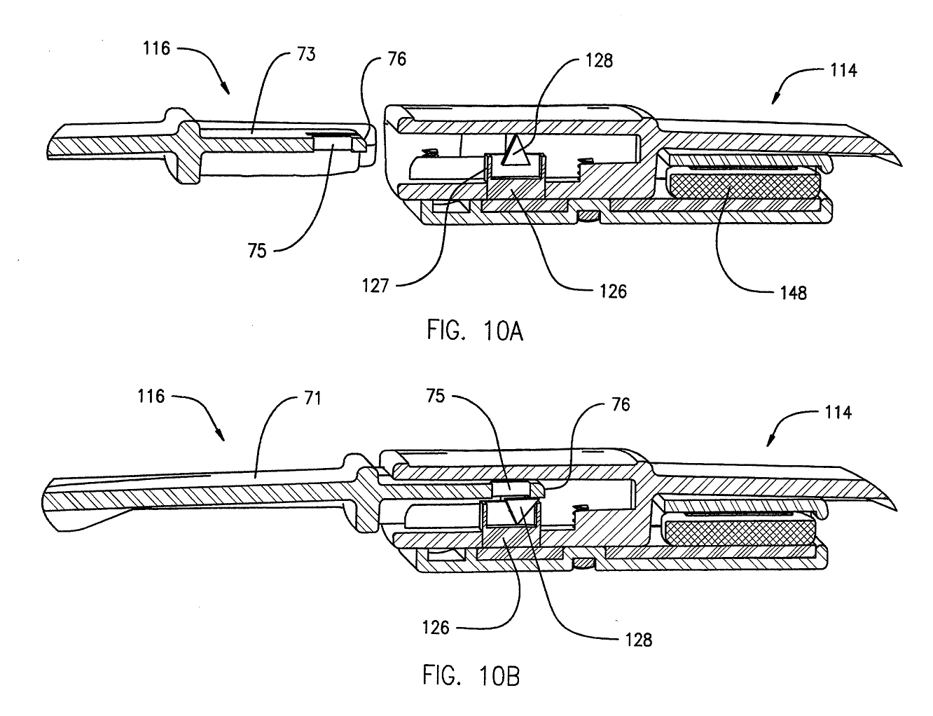

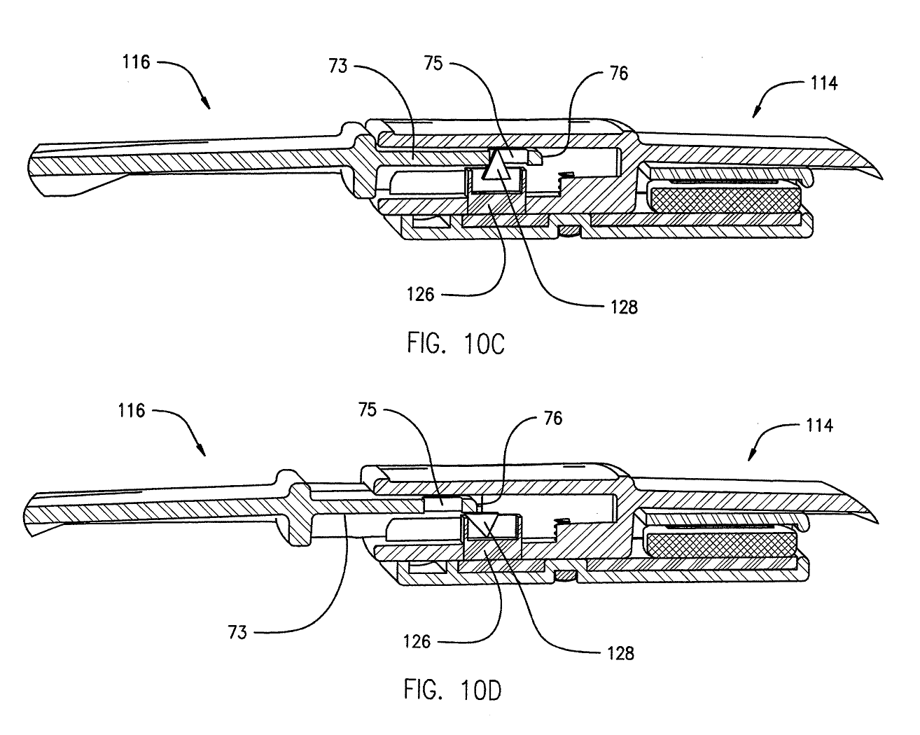

In the process of buckling and unbuckling, as shown in FIG. 10B, as the alignment arm 73 approaches and comes into registry with the detector switch 126, the leading edge 76 of the alignment arm 73 engages and biases the lever arm 128 from its neutral position rearwardly, away from the front opening 80, to a first toggled position, energizing the RF transmitter 132 through the PCB circuitry to initiate a broadcast or transmission of a buckled signal (as described above).

After the leading edge 76 of the alignment arm 73 clears the switch 126, the lever arm 128 returns to its neutral (off) position, as shown in FIG. 10C.

As the latch 116 is released from the buckle 114, as shown in FIG. 10D, the slot opening 75 of the alignment arm 73 is moved out of registry with the detector switch 126, and the leading edge 76 of the alignment arm engages and toggles the lever arm 128 forwardly from its neutral, off position toward the front opening 80 and to a second toggled position. When the lever arm 128 is moved forwardly, the PCB circuitry energizes the RF transmitter 132 to broadcast an unbuckled signal. After the leading edge 76 has cleared the switch 126, the lever arm 128 returns to its unbiased neutral (off) position, as shown in FIG. 10A.

When the latch member 116 is disengaged and withdrawn from the secured position within the buckle member 114, the lever 128 is toggled to a second position from the center neutral position. The RF transmitter of the buckling detector sends an unbuckled signal when the lever arm toggles to the second position during disengagement of the latch member from the buckle member.

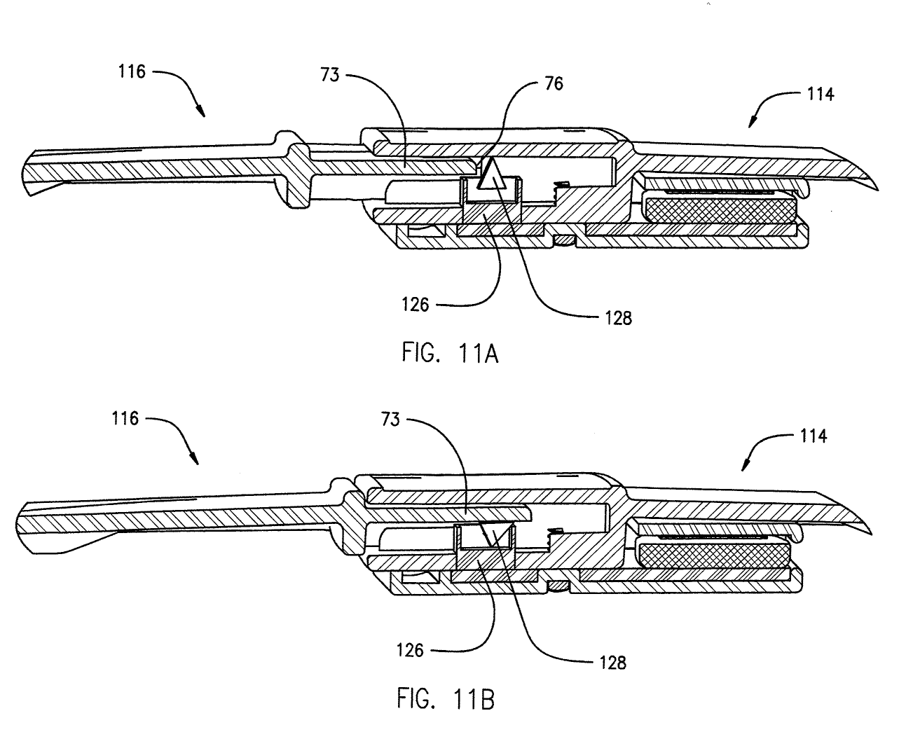

Another embodiment shown in FIGS. 11A and 11B, the detector switch 126 is a single pull, single throw (SPST) switch. In an embodiment using only one SPST switch, the buckling detector 125 sends only a ‘buckled’ signal when the latch is secured from the buckle, and retransmits a ‘buckled’ signal at predefined intervals until such time as it is unbuckled. It does not send an ‘unbuckled’ signal when the latch is unclipped from the buckle. The lever arm 128 of the detector switch moves between a center, neutral position and a single throw position. The lever arm 128 toggles to the single throw position from the neutral position when the latch member 116 is inserted into the buckle member 114 to the secured position, and remains in the single throw position while the latch member 116 is secured to the buckle member 114. The lever arm 128 returns to the neutral position when the latch member 116 is disengaged and withdrawn from the buckle member 114. In this embodiment, the RF transmitter 132 of the buckling detector 125 sends a buckled signal when the lever 128 toggles to the first or single throw position. Optionally the buckling detector 125 can be programmed for the RF transmitter sending a buckled signal for a specified or indefinite time, intermittently or continuously, for so long as the lever 128 remains toggled to the first position. The RF transmitter 132 ceases sending the buckled signal when the lever arm departs from the single throw position.

In an embodiment employing a SPST switch as shown in FIGS. 11A and 11B, the insertion of the latch 116 into the buckle 114 to the secured position results in the alignment arm 73 to engage and bias the lever arm 128 into the first toggled position, energizing the RF transmitter 132 through the PCB circuitry to initiate a broadcast or transmission of the buckled signal. The alignment arm 73, lacking a slot opening or other comparable opening, holds the lever arm in the first toggled position for so long as the latch 116 is secured to the buckle 114. When the latch 116 is released from the buckle 114, and the leading edge 76 of the alignment arm is withdrawn from the switch 126, allowing the lever arm 128 to return to its unbiased neutral (off) position.

The buckled signal and the unbuckled signals can include an encryption code, a unique identity code for the chest clip, the respective buckled or unbuckled signal code, and optionally a battery voltage check code and an ambient temperature check code.

An example of a chest clip, including the latch member and the buckle member, is a SafeGuard chest clip, available from IMMI. The chest clip can be modified to accommodate the buckling detector 125 by forming an opening for the toggle switch in the buckle member, and securements for the PCB 73.

A non-limiting example of a one-way detector switch is a single pull, single throw switch, model ESE18, available from Panasonic Corp. A non-limiting of a two-way detector switch is a single pull, double throw switch, model ESE24, available from Panasonic Corp. A non-limiting example of an RF transmitter is a crystal-less SoC transmitter, model Si4010-C2, available from Silicon Laboratories, which include CPU and data storage memory and 10/14 circuitry interface pins.

The buckling detector of the present invention can be programmed for instructing the RF transmitter to send a buckled signal when the lever arm toggles to the first position, and optionally an unbuckled signal when the lever arm toggles to the second position. Both the buckled signal and the unbuckled signal can include an encryption code, a unique identity code, the respective buckled or unbuckled signal code, and optionally a battery voltage check code and an ambient temperature check code. The encryption code is typically a 40-bit rolling code, comparable to the encryption systems used in remote keyless-entry systems of todays'automobiles, as described in “How Remote Entry Works” (http://auto.howstuffworks.com/remote-entry2.htm). The unique identity code is typically a 32-bit code that is preselected to uniquely identify the buckling detector, and therefore it uniquely identifies the chest clip and the child safety seat to the control system. The buckle and unbuckle code can be a short-bit (e.g., 1-4 bits) signal to distinguish the two signals. Alternatively a cyclic redundancy check (CRC) code can provide a means for the detection of burst errors during digital data transmission and storage of the buckle status signal. The battery voltage check code and the ambient temperature check code can be short-bit “good” or “no-good” codes, or a short-bit voltage value or short-bit ambient temperature value. The buckle signaling device is a self-powered device that does not rely upon power from the vehicle's electric system, and the onboard battery provides the sole source of power to this device. A 3-volt nickel-cadmium battery is typically sufficient to provide power to the device for several years. To minimize power requirements, the seat buckle status processor can include circuitry and controls that minimize power consumption except at the moment when the child seat buckle assembly is ‘buckled’ from an unbuckled state, or is ‘unbuckled’ from a buckled state.

It can be understood that the two-way detector switch, battery and RF transmitter of the chest clip can be employed in the lap buckle assembly illustrated in FIGS. 2-5. For example, a slot opening or recess can be formed in the metal latchplate of a conventional lap buckle to accommodate the two-way detector switch in its neutral, off position when the latchplate is securely inserted into the buckle.

### The Portable Controller Device:

A portable controller device 50 includes a transmission receiver that receives the buckle status signal, a means for detecting the ignition status of the vehicle, a means for generating an alarm signal in response to a predetermined condition of the ignition status and the buckle status signal, an optional alarm that is responsive to the alarm signal, and an interface for connecting to the OBD-II port of the vehicle. The portable controller device 50 can also include a means for communicating with the vehicle's onboard network (CAN or other network) through the OBD-II port. The functional components of the portable controller device 50 are enclosed within a housing or covering.

The portable controller device 50 can include connector 51, illustrated as a 16-pin Data Link Connector (DLC) 51, as an interface connection that plugs into the On-Board Diagnostic (OBD)-II vehicle port 100 of the passenger vehicle. The vehicle's OBD-II port is required by Regulations to be positioned within a specified distance from the driver's seat/steering column of the vehicle. As intended by the federal regulations that mandate the installation of the OBD-II port in all passenger vehicles and light trucks sold in the US since 1996, a user can plug the portable controller device 50 into the OBD-II vehicle port 100 in a manner of seconds, with a simple plugging-in motion and without any tools.

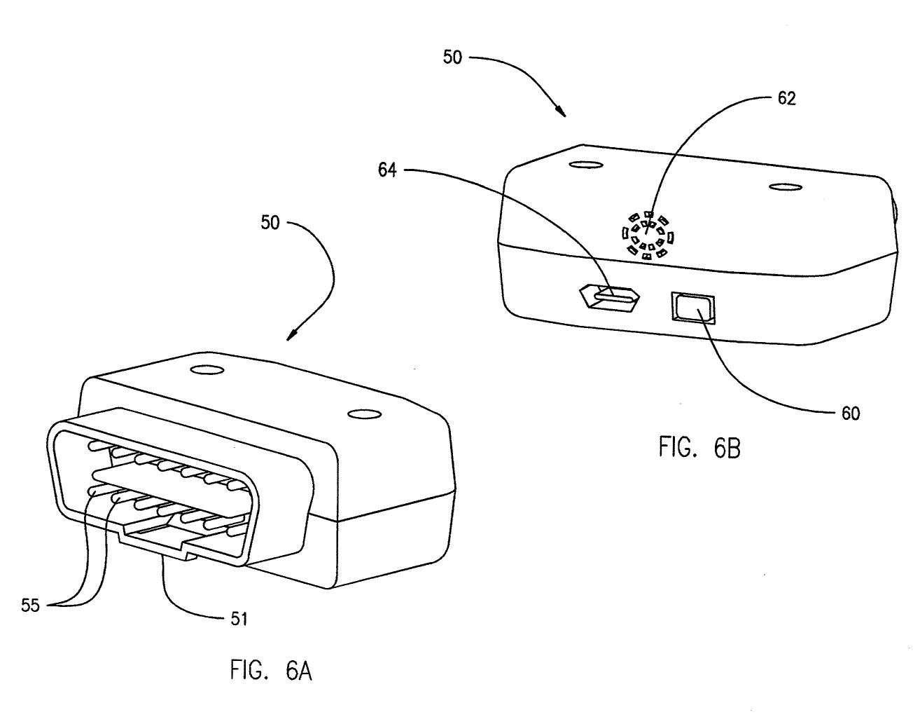

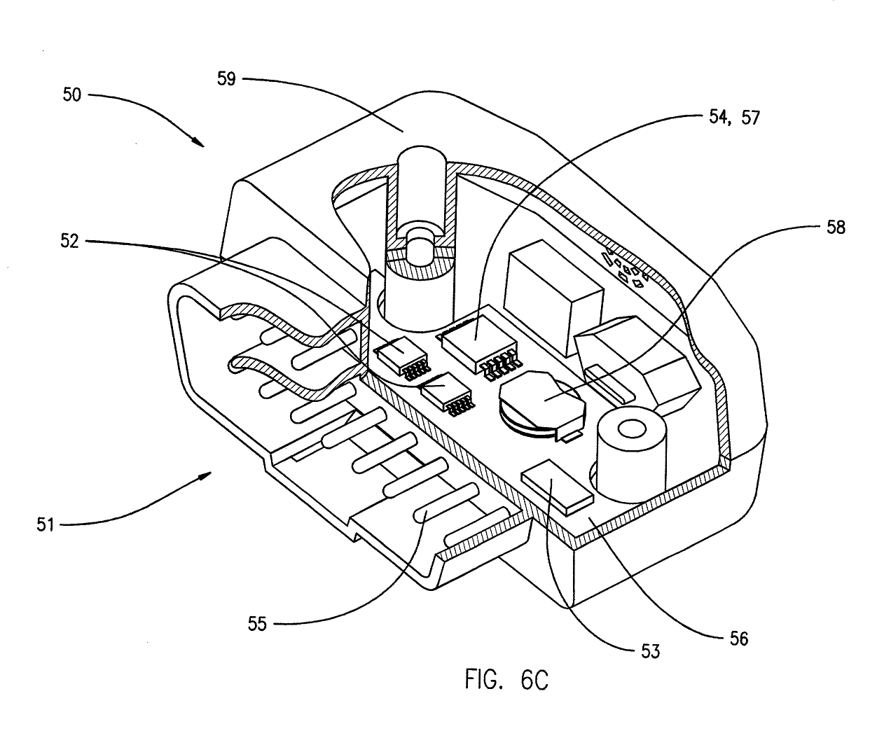

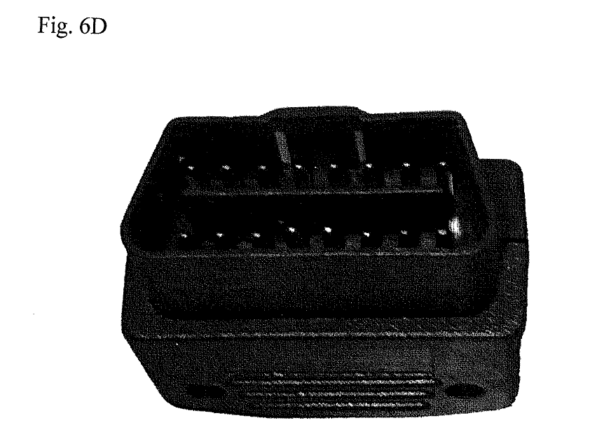

Once plugged in to the OBD-II port, 12-volt power is delivered to the portable controller device 50 from the vehicle's electronics system, which is typically run through a voltage regulator to output between 3 and 5 volts direct current, to directly power a microprocessor 52 and other components of the portable controller device 50. As illustrated in FIGS. 6A, 6B and 6C, the microprocessor 52 and other components (including the voltage regulator, though not shown) are mounted to a PCB 56 within the housing 59 of the portable controller device 50.

In one embodiment of the invention, the portable controller device 50 can establish a physical interface with the vehicle's ignition system, by reading only the pins 55 of the DLC 51 for the automobile's battery and a ground connection. In this embodiment, the DLC 51 can have only such two pins for the battery and ground. Alternatively, the DLC 51 can include additional and up to the remaining 16 pins 55 in electrical communication with a microprocessor 52. The means for detecting the ignition status of the vehicle can include the battery pin of the DLC 51 that electrically contacts the battery pin of the OBD-II port, the ground pin of the DLC 51 that electrically contacts the ground pin of the OBD-II port, the microprocessor 52, and a voltmeter for detecting of the voltage potential across the battery pin and the ground pin of the portable controller device. The microprocessor 52 can include programming and data storage for monitoring the voltage of, or the voltage differential between, the battery and ground pins, and for interrogating the hysteresis data of the voltage differential of the battery and ground pins, in order to detect the vehicle ignition status. While the use of voltage drops or rises to determine the ignition state of a vehicle may be employed, it has been discovered that long periods of time (such as 120 seconds or greater) of a sustained voltage drop are required to establish with certainty an ignition ‘off’ state. In more reasonable and realistic scenarios that require a rapid response to vehicle ignition state, a voltage rise or drop may not be a reliable indicator of ignition state of the vehicle. Part of the reason for this determination is the wide variability from vehicle to vehicle of both alternator response to load, designed voltage peak and steady state variations, as well as internal capacitance and layout of the vehicle's electrical system. One vehicle may rapidly drop from an ignition steady state of 14.4 volts ‘on’, down to 11.9 volts ‘off’, over a period of 2 seconds, while another vehicle may maintain a 13.8 volt ‘on’ state, yet require 45 seconds to decay to 12.6 volts, and 120 seconds to reach 11.9 volts.

In addition, transient yet typical loads such as the use of a defroster or air conditioner while the vehicle is traveling, can cause varying voltage drops of from 2-3 volts, depending on the type of vehicle, with a lag from a few tenths of a second, to many seconds, to return to a steady state ‘on’ voltage. This is again due to the widely varying function of various alternator charging circuits seen across the spectrum of current vehicles

Consequently, neither the magnitude of a voltage drop, nor the rate of change of voltage drop can serve as a reliable and fail-proof indicator of ignition state for any process requiring near real-time ignition status.

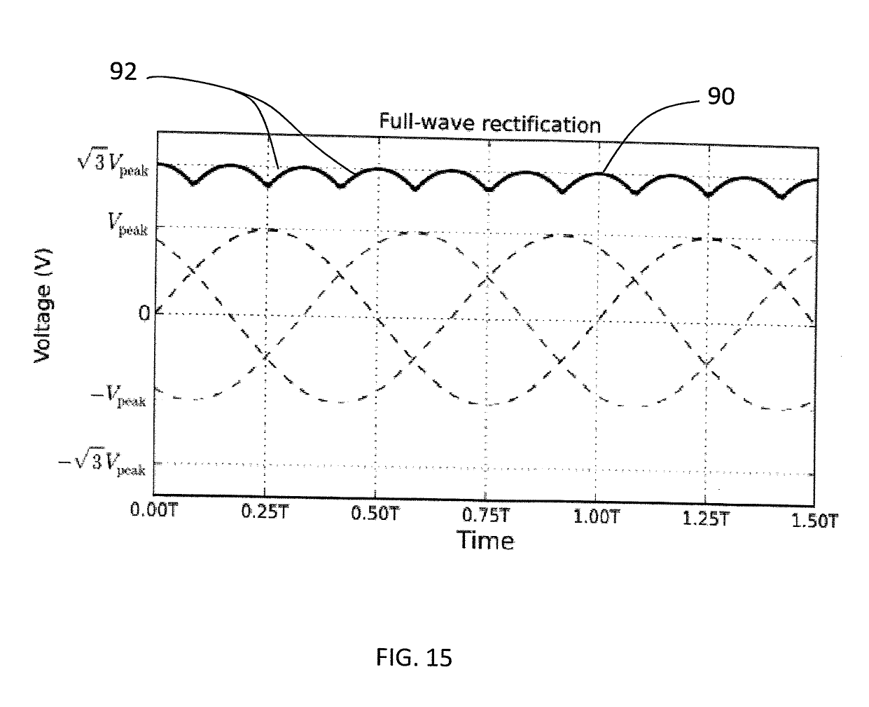

The present invention provides a method of detecting ignition state by sampling the voltage of an electrical system that converts an alternating current to a rectified direct current (rectified DC). An operating alternator produces a sine-wave, alternating current (AC). A rectifier device converts the alternating sine-shaped signal into a non-alternating, or pulsing, direct current (DC) signal. To reduce pulsations, a smoothing circuit or filter, which can consist of a reservoir capacitor or smoothing capacitor, is placed at the DC output of the rectifier device. An illustration of a rectified DC signal 90 is shown in FIG. 15, with ripples 92 in the resulting rectified DC signal. Nevertheless, an amount of voltage ripple typically remains in the voltage signal, which is not completely smoothed. Detecting of this voltage ripple in the electrical circuit provides a novel means for detecting the ignition state of the vehicle, and more specifically, that the engine of the vehicle is running. Consequently, the present invention provides a method and a device for detecting pulses or ripples in a rectified AC signal. The detected pulses or ripples can provide an ignition status signal, for use in the methods and devices of the present invention. When the ignition is turned off and the engine stops “running”, the output of the alternator and rectifier turns off. The voltage in the circuit is essentially battery DC or “chemical DC” voltage, typically a flat, smooth, and steady voltage. A battery DC voltage signal (vehicle ‘off’ state) will exhibit very little variation from DC baseline, usually not more than a few millivolts. By comparison, the amplitude of the ripples in voltage of a rectified DC are greater than, typically by two, three, four, five, or six, or more, orders of magnitude, than variations in the voltage of a battery DC signal.

Fast Fourier Transformation (FFT) of discrete data points sampled from a signal can be used to detect the presence of a sine wave within the signal. A drawback is that such FFT sampling and mathematical testing for the presence of a sine wave is computationally intensive and thus poorly suited to a small, slow microprocessor with limited memory, such as those found in vehicles or in aftermarket electronic devices. Furthermore, rectification of the AC alternator output to a DC-like voltage signal modifies the true sine wave quality of the signal, making sine wave detection more difficult.

A voltage detecting device is used to detect and monitor the voltage of the electrical ignition circuit down to the millivolt level. Using a circuit board (a printed circuit board, or PCB) that has been appropriately noise-suppressed from an electrical standpoint (to avoid generating voltage fluctuation on the PCB itself that would overrun the detected signal), variations or ripples in the circuit that exceed the expected flat, smooth baseline of a battery DC signal can be detected.

For example, a conventional DC baseline voltage from a vehicle battery may have a 1 millivolt amplitude of variability in its signal, while an alternator-supplied and rectified DC voltage signal may have a 20 millivolt amplitude above a voltage baseline. This higher amplitude variation can be detected with regular and closely spaced sampling. When the higher amplitude variation exceeds a selected threshold value, one can conclude that the DC voltage signal is from a rectified AC source, and that the vehicle is in the ‘on’ state. The present invention thus provides a device and a method for detecting that a vehicle is in either the ‘on’ or ‘off’ state with high reliably and within fractions of a second.

In another embodiment of the invention, the portable controller device 50 can establish both physical interfaces and a software and control interface with the vehicle's computer and control system via the OBD-II port. The physical interfaces are established when the DLC 51 is plugged into the OBD-II port and the ignition system powers on the vehicle. This physical interface is an electrical signaling standard that defines what voltages or patterns of voltages translate to 0s and 1s. The software and control interface establishes a protocol that maps patterns of 0s and 1s to messages to and from the car.

Each of the physical interfaces on the OBD-II port uses a separate pin 55 or pairs of pins 55 on the OBD-II port. To determine which physical interface is present, the portable controller device 50 is plugged into the OBD-II port for a first time, and ‘listens’ to all of the available physical interface pins and monitors their peak voltages. When the driver turns the vehicle ignition ‘on’ for the first time, the portable controller device 50 detects on which interface pin 55 or pins the communication electronic messages are traveling, and memorizes these until the portable controller device 50 is unplugged from the OBD-II port. Thus, the vehicle should be turned ‘on’ at least once after the portable controller device 50 is plugged in, for the functions and features of the device 50 to work properly. This also establishes for any vehicle that, regardless of the make, model and year, the ignition is ‘on’.

Some makes and models of vehicles have only one default software protocol for the physical interface, such that no further learning is required after the physical interface of the device 50 is plugged into the OBD-II port 100. In later-model vehicles, other physical interfaces that include CAN and single-wire CAN use an extended version of the default protocol to control advanced features of the vehicle, including horns, windows, et cetera. The device 50 queries the vehicle system for the make, model and year of manufacture as identified by the vehicle identification number (VIN). This VIN information can be obtained using the default protocol from any vehicle equipped with an OBD-II port 100. Once the vehicle is thus identified, the device 50 can look up access and control codes stored on the device 50, and send such codes for controlling the various vehicle systems.

The controller device 50 continues to receive electrical power from the vehicle, even after the ignition is turned to ‘off’ and the key removed, such that it can continue to monitor child seat(s) buckle states, and transmit alarm signals as needed, and/or control alarm signal-responding features of the vehicle as needed, through the OBD-II port 100. The VIN information is also retained. When the device 50 is unplugged from the OBD-II port, the volatile memory is lost, which allows the device 50 to ‘relearn’ the interfaces and protocols of the same vehicle the next time it is plugged in, or to newly learn the interfaces and protocols of a different vehicle into which it is plugged.

The microprocessor 52 and one or more networking transceivers 53 can detect, and provide a means for detecting, CAN or other network systems on the vehicle, can interrogate, and a provide a means for interrogating, the vehicle network(s) for vehicle identifying information to determine availability of various advanced features of the vehicle, and can send, and can provide a means for sending, messages and signals to control such advanced features of the vehicle. The networking transceiver 53 connects to the various pins of the DLC 51 and to the microprocessor 52. The microprocessor 52 provides a means for generating an alarm signal in response to a predetermined condition of the ignition status and the buckle status signal.

Having established the identity of the vehicle and established communications with the vehicle's CAN, the microprocessor 52 periodically interrogates the status of the vehicle's ignition system, and in particular detects that the ignition system has either an ‘on’ status or ‘off’ status. In an aspect of the invention, ‘on’ status means that engine is turning or running, or, the ignition system is turned (with the key inserted) to an ‘accessories’ or ‘on’ position, and ‘off’ means that the engine is not running, and the ignition system is turned to its ‘off’ position.

### ‘Learning’ of the Child Seat Device by the Controller Device

The invention includes a method for the association of or pairing the child seat restraint device and the portable controller device; this is also described as the seat being ‘learned’. This learning may occur through a number of physical or logical actions, some of which are described below.

In an optional embodiment of the invention, the portable controller device is first placed into a ‘learn’ mode. This may be accomplished by the use of a predetermined sequence of ignition on/off events that would be highly unlikely to occur in everyday use of a vehicle. Alternatively, the portable controller device 50 may have a learn button (not shown) on its outer case surface that will put the device into a learning mode once briefly depressed. In another embodiment, the controller device is programmed to recognize a predetermined sequence and timing of ‘buckled’ and/or ‘unbuckled’ signals from the restraint device as a request to be ‘learned’ by the controller device.

Once in ‘learn’ mode, the portable controller device may optionally provide an audible and/or visual signal to the user that it is in learn mode. This may include a synthesized voice through the speaker and/or a predetermined sequence of beeps and/or flashes of a light (an LED) disposed in the housing.

The user will then have a certain period of time within which to ‘introduce’ each seat to the portable controller device by executing a predetermined sequence of buckling and unbuckling the seat. The portable controller device 50 may acknowledge each seat “learned” by appropriate audible or visual signaling to the user.

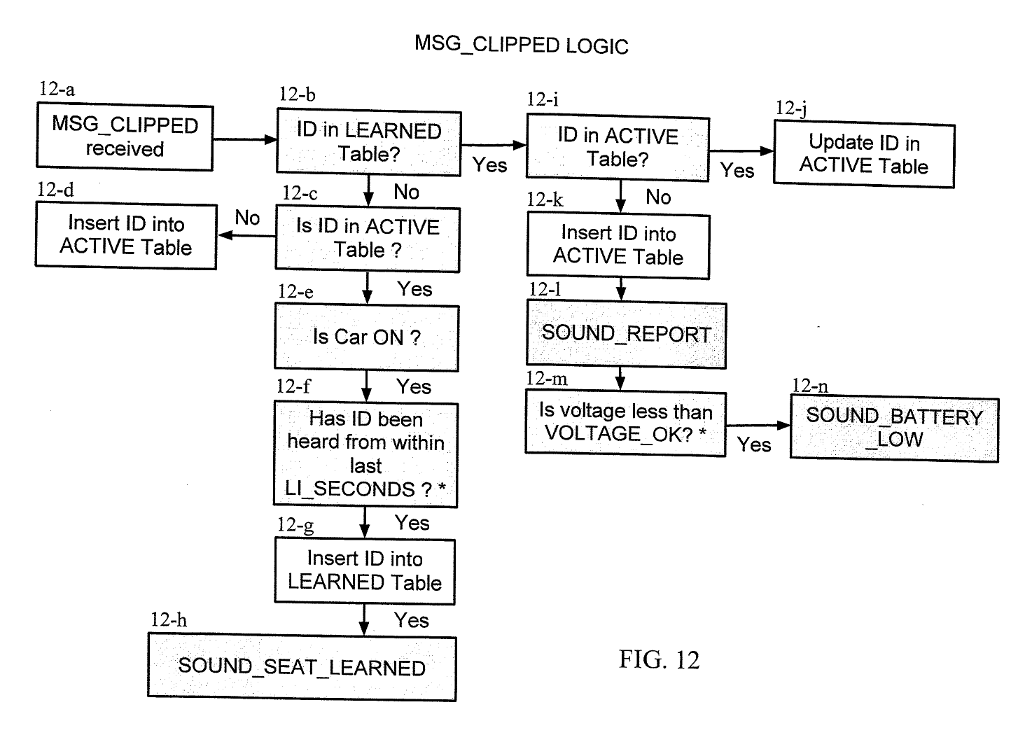

In another optional embodiment of the system, FIGS. 12, 13 and 14 show logic diagrams for a system that programs the controller device to recognize signals from the child seat's restraint device to be ‘learned’. In this example, to associate a child restraint device with a particular vehicle, the user turn on the vehicle (to set the ignition status to ‘on’) and performs two buckling-and-unbuckling cycles of the latch to the buckle within 5 seconds of each other, while the engine ignition is ‘on’.

To initiate the “seat learning”, the user buckles the latch to the buckle of an ‘unlearned’ restraint device a first time to generate a ‘buckled’ status signal, shown in block 12-a “MSG_CLIPPED received” in FIG. 12. In Block 12-b “ID in LEARNED Table?”, the controller device queries if the unique identification (ID) code assigned to the restraint device is already saved in the LEARNED Table of its memory. If not, then the controller device queries in Block 12-c if the ID code assigned to the restraint device is saved in the ACTIVE Table of its memory. If not, then the ID is inserted into the ACTIVE table in its memory (Block 12-d). This is what occurs on the first ‘buckling’ of the latch to the buckle. The ID is ‘active’, but not ‘learned’, which occurs in a fraction of a second.

After unbuckling the latch, the user inserts the latch a second time into the buckle (Block 12-a again) within 5 seconds of the first latch buckling. When the controller device queries (Block 12-c) if the ID code is saved in the ACTIVE Table of its memory and determines affirmatively, the controller device proceeds to confirm that the vehicle ignition is ‘on’ (Block 12-e), and then queries if the ID has been heard from within the last “LI_SECONDS”, where “LI_SECONDS” in a defined learning internal, which in this illustration is 5 seconds. Having done so, the ID is inserted into the LEARNED table (Block 12-g), and sounds a “SEAT LEARNED” signal (Block 12-h). The seat's restraint device is now ‘learned’.

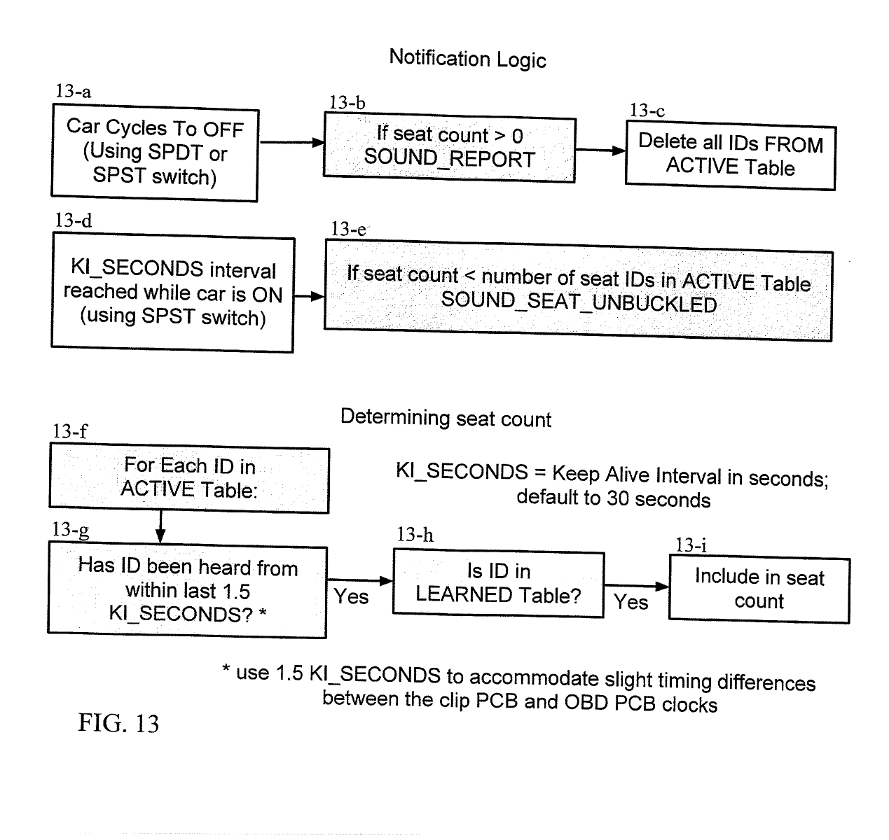

Once the seat device ID is ‘learned’, the vehicle ignition is turned ‘off’, shown as Block 13-a of FIG. 13. The system logic is configured to issue a SOUND_REPORT transmission (alert) as soon as the ignition is turned off, if a child seat device is ‘unbuckled’. And in the illustrated logic, since the learned ID has been heard from “within the last 1.5×KI_SECONDS” (Block 13-g), where the “KI_SECONDS” is the designated Keep-Alive time period of the device, typically about 30 seconds, and the ID is in the LEARNED table (Block 13-h), the learned ID is in the seat count (Block 13-i). (A “1.5×” period is used to accommodate the slight timing differences between the clocks of the child-side PCB and the controller-side PCB.) Consequently, after Block 13-a, since the seat count is greater than 0 (Block 13-b), the controller emits a SOUND_REPORT signal, and then deletes the learned ID form the ACTIVE table (Block 13-c). In effect, the system logic deletes all the IDs from the ACTIVE table every time the ignition is turned off. Whether a restraint device employs an SPDT (SPCO) switch or an SPST switch as a buckling detector, the learning proceeds in substantially the same way.

It can be understood that the learning may involve performing a larger number of buckle-unbuckle actions, such as 3, 4, 5 or more, and performing the required number of buckle-unbuckle actions within a different prescribed time period, for example, 5 seconds, or 10 seconds, depending on product and consumer need or preference.

Once learning is complete for all desired seats, the portable device controller can be placed into regular, non-learning operating mode by either a predetermined sequence of ignition on/off events, or optionally repeat depression of a learn button on the portable device controller device (not shown), or simply expiration of the predetermined learning period. The portable device controller may then optionally provide audible and/or visual signal to the user that it is back in regular operating mode.

The identity of the learned seats are retained in nonvolatile memory. The portable controller device can include sufficient memory to accommodate dozens of learned seats. In the unlikely event that memory space is filled, newly learned seats will displace earliest learned seats in memory, in a ‘first in, first out’ fashion. The user would be made aware of the fact that a previously learned seat has been displaced from memory, or that a child seat with a never-learned restraint device is being used, when the user fails to receive the expected previously described audible and/or visual signal from the system acknowledging buckled status. The user would then be aware that the seat is not recognized and must be learned for a first time, or re-learned due to being displaced from memory.

The portable controller device will not track states for, or react to, buckled status signals from unknown seats that are not recognized or previously ‘learned’. This will avoid the possibility of an adjacent (stranger) vehicle's seats causing false positive alarms. The next time the ‘learned’ restraint mechanism is ‘buckled’ (Block 12-a), it is not in the ACTIVE table (Block 12-i), so its ID is inserted into the ACTIVE table (Block 12-k) with a SOUND_REPORT alert (Block 12-1). Thus, when a ‘learned’ child seat is re-buckled, an alert sounds to confirm the ‘buckled’ state for the parent. At each ‘reactivation’ of the ID in the ACTIVE table, a battery check can be performed (Block 12-m and 12-n).

FIG. 12 also shows that for each switch device that emits a “Keep-Alive” transmission, the ID of the learned, active ID is updated in the ACTIVE table (12-j) and the next keep-alive check interval is begun.

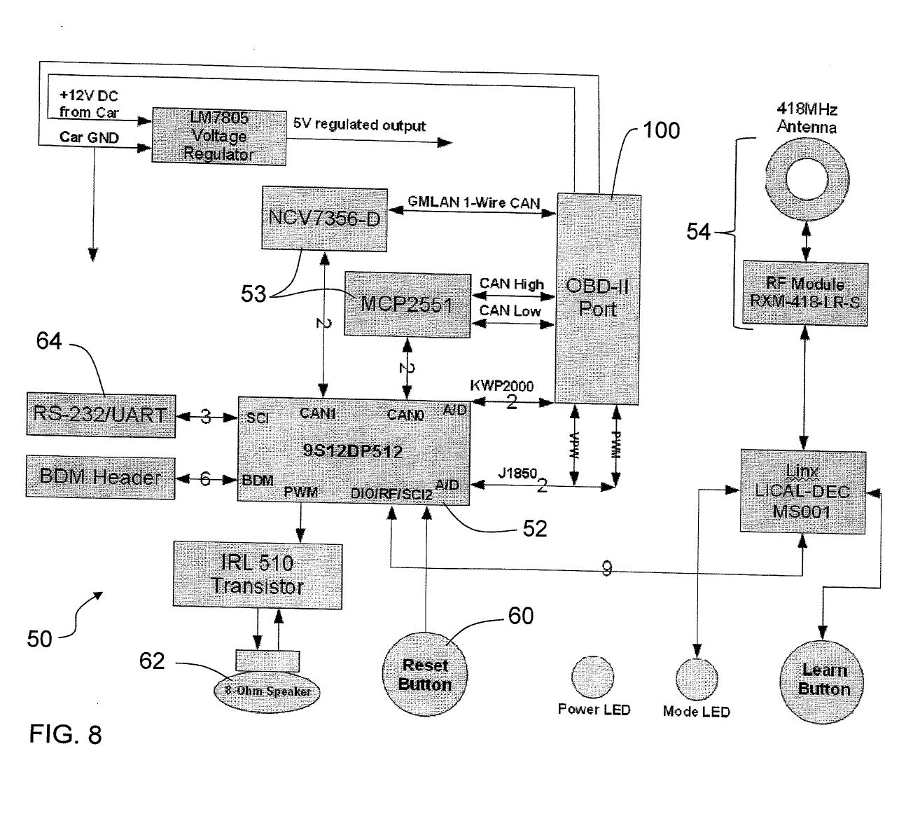

The components that can be employed in the buckle signaling device and the portable controller device are widely available, and a person skilled in the art can select appropriate components using published information and specifications. By way of example, and without a limitation whatsoever, an example of a buckle status signal transmitter 32 for the buckle signaling device and for a transmission receiver 54, are the Linx LR transmitter with Linx MS encoder, and the Linx LR receiver with Linx MS decoder, available from Linx Technologies; an example of a controller 52 is a Freescale 9S12DP512, available from Freescale Semiconductor, Inc.; and an example of CAN transceivers 53 includes a single wire NCV7356SWCAN transceiver and a dual wire MCP2551CAN transceiver, both from Texas Instruments. FIG. 8 shows a block diagram for a non-limiting prototype of the portable controller device 50 that plugs into the OBD-II port 100. Featured components of the device 50 include the microprocessor 52 (the Freescale 9S12DP512), two CAN transceivers 53 (the single wire NCV7356SWCAN transceiver and the dual wire MCP2551CAN transceiver), the RF transmission receiver 54 (Linx RXM-418-LR-S with antennae), the on-board speaker 62 (8-ohm, including IRL 510 transistor), and reset button 60, along with other optional components including a “power on” LED indicator, an operating mode LED(s), an on-board “learn” button, as well as microprocessor pin requirements and connections.

Communication Between the Child Restraint Device and the Portable Controller Device

The portable controller device 50 includes a transmission receiver 54 that listens for and receives the buckle status signal 200 from the seat's restraint device 11. The transmission receiver 54 receives the buckle status signal 200, as a ‘buckled’ signal only when the status of the restraint mechanism 12, is ‘buckled’. The transmission receiver 54 can also receive a distinct ‘unbuckled’ signal from the restraint device 11 when the latch 16, 116 of the child seat restraint mechanism 12,112 is ‘unbuckled’ from the buckle, and treats the child restraint system as unbuckled for the purposes of action and response.

Upon initial receipt of the ‘buckled’ signal by the transmission receiver 54, the controller 52 can emit an ‘all-secured’ signal, which can include an audible or visible signal, such as one or more beeps through the speaker 62, indicating to the parent or guardian who has just buckled in the child that the system acknowledges the buckle status as ‘buckled’, which typically coincides with the illumination of the ‘buckled’ LED 38 on the child-side buckle signaling device 11. It is noted here that since the portable controller device 50 remains plugged into the OBD-II port at all times and always has (vehicle battery) power, the listening for and detection of buckle status signal 200 transmitted from the child seat-side device 11 goes on continuously. In this way, the child can be buckled into the child safety seat and acknowledged by the system even before the ignition is started.

In the general implementation, all restraint devices may, whether using an SPDT (SPCO) or an SPST type switch, transmit an initial ‘buckled’ message upon first buckling, and also continue to re-transmit a ‘buckled’ message at a predefined interval known as the ‘keep-alive’ interval.

The keep-alive transmissions provide a means of eliminating false positive seat states, as described above. The failure of the system to receive an expected keep-alive transmission also may also serve as an implied unbuckled event. This may be the only means of detecting an unbuckled status, or may be a secondary means of determining a seat's unbuckled status, as described below.

It can be understood that the OBD controller device may be programmed to require the receipt of several keep-alive ‘buckled’ messages from a learned seat prior to the seat being considered active. This may vary based on manufacturer or consumer need. This logical criteria may allow the device to ignore likely false positives.

For example, imagine two family vehicles in a garage, each vehicle containing portable OBD controller devices that have learned the family's car seats. A portable OBD controller device that is programmed to require the receipt of several ‘buckled’ messages sequentially before considering the seat to be active would eliminate most false positives, presuming the vehicle containing the active seat left the garage (and thus went out of RF range) prior to the expiration of a predefined number of keep-alive intervals.

In the case of a restraint device using an SPDT (SPCO) type switch, in addition to the transmission of ‘buckled’ messages as above, an ‘unbuckled’ message is transmitted immediately upon unbuckling. This allows immediate recognition by the system that the seat is unbuckled.

In the case of a restraint device using an SPST type switch, an unbuckled status is inferred by the system when the expected re-transmission of the ‘buckled’ message is not received at the expiration of the predefined multiple of the keep-alive interval (“multiple”=1.5× in FIG. 13, Block 13-g).

It can be understood that an unbuckled state may also be inferred, even for a seat using an SPDFT(SPCO) switch, if, as in the case of the seat using an SPST switch, the expected ‘buckled’ message is not received.

Each switch type offers certain advantages and disadvantages. An advantage of the SPDT(SPCO) switch is that it provides desirable, immediate feedback to the system as to an unbuckled state. A disadvantage of the SPST switch is that use results in a lag time of anywhere from zero seconds to 1.5× the keep-alive interval in seconds before the system becomes aware of an unbuckled state.

This brief time lag when using the SPST switch may be an acceptable compromise due to several advantages the SPST switch offers. Specifically, the SPST switch may fit more easily into a given seat buckle or clip geometry. It may also offer more fail-safe performance, eliminating the need for a separate transmission by a seat to communicate an unbuckled status to the system.

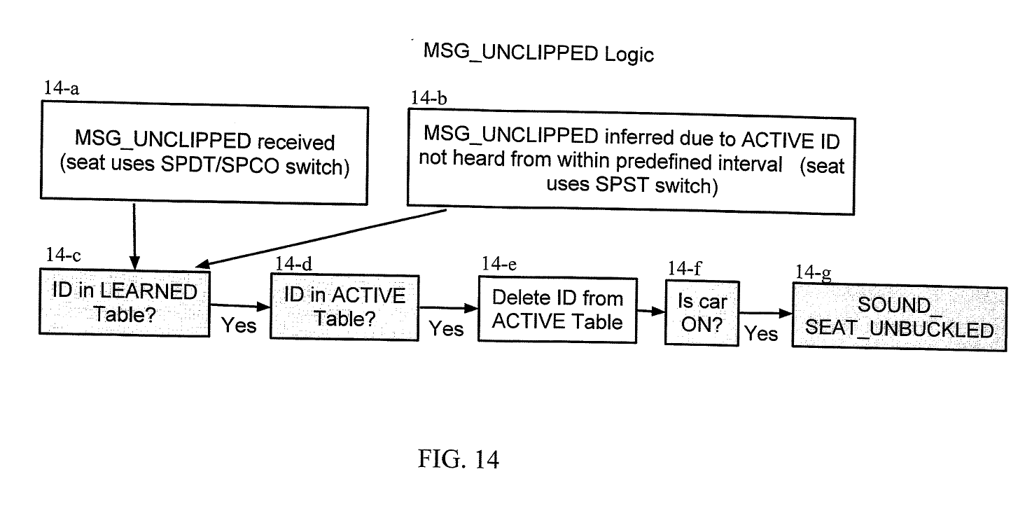

FIG. 14 shows the logic used by the controller device when the restraint device is ‘unbuckled’. (This state is recognized upon either receipt of an affirmative ‘unbuckled’ signal (Block 14-a), or the failure to receive an expected “Keep-Alive” signal (Block 14-b).) The controller device is queried to determine if the unique ID of the restraint device is already saved in the LEARNED Table of its memory (Block 14-c), which it has been. This guards against an ‘unbuckle’ signal from a nearby child seat restraint device owned by another family causing a false positive. The controller device then queries if the unique ID of the restraint device is saved in the ACTIVE Table of its memory (Block 14-d). If it has been, the unique ID is deleted from the ACTIVE table (since the latch is unbuckled) (Block 14-e). If the vehicle's ignition is ‘on’(ON in Block 14-f), the system assumes that the child has improperly unbuckled the latch, and the SOUND_SEAT_UNBUCKLED audible signal is generated (Block 14-g).

The ‘keep-alive’ transmission provides a unique solution to many functional problems inherent in the creation of an effective real-world child seat safety system. For example, the ‘keep-alive’ logic solves the problem of recognition of a child safety seat employing the system that is initially ‘buckled’ outside of radio frequency (RF) detection range of the system. This situation is common with infant carrier type seats, where a child may be placed into the infant carrier seat in the home, and then carried out to and placed into the vehicle. During this entire time, the restraint device is transmitting the ‘buckled’, ‘keep-alive’ signal.

The ‘keep-alive’ logic also permits the system to distinguish between intermittent stray messages received from a restraint device associated with a nearby unrelated child seat, and the signals from related child seats that remain for a predefined number of intervals within the RF range of the system. This may happen, for example, when two family members pull out of the garage at the same time within RF range of each other, as described previously. False-positive seat identifications are virtually eliminated.

Use of keep-alive logic with an appropriately chosen keep-alive interval permits the restraint device to spend the majority of its time in a ‘sleep’ state, to optimize signaling device battery life.

In a typical operation, a child is placed into the vehicle (ignition ‘off’) and is buckled in. This results in the controller receiving a MSG_CLIPPED or ‘buckled’ signal (Block 12-a). If the restraint device is learned (yes, Block 12-b), the controller is informed that the ID is not in the ACTIVE Table (no, Block 12-i); the ID is inserted into the ACTIVE Table (Block 12-k), and emits a SOUND_REPORT sound (BLOCK 12-1) to let the user know that the system has recognized the ‘buckled-in’ child. (At this time, the voltage of the battery in the restraint device is checked (Block 12-m) to ensure it has life; if the power is low, a SOUND_BATTERY_LOW sound is emitted (Block 12-n).

As the vehicle moves along to its destination with the child in the seat, a restraint device that emits a “Keep-Alive” signal continuous to receive the intermittent “keep-alive” signal from the learned restraint device (Block 13-g), and includes the ID in the seat count (Block 13-i). If the child gets curious and unbuckles his seat, then after a period of time after the keep-alive period has expired, the seat count drops to zero, and a SOUND_SEAT_UNBUCKLED alarm is emitted (Block 13-e) to warn the driver that the child is unbuckled with the vehicle ignition ‘on’.

At the destination, the vehicle ignition is usually turned off first (Block 13-a). If the controller recognizes the buckle status of any restraint devices as ‘buckled’, then a SOUND_REPORT is sounded (Block 13-b) as a notification to the parent that one or more children are still buckled in the seat. At the same time, all IDs are removed from the ACTIVE table (Block 13-c).

It can be understood that the controller can also programmed to initiate additional alerts to the parent in case the child remains ‘buckled” in the seat, as described elsewhere in the description.

In an aspect of the invention, when the ignition is started after the child is buckled in, the controller can emit a second ‘all-secured’ signal, which can be the same or distinct from the first ‘all-secured’ signal, indicating to the parent or guardian that the system is armed and ready to alert the parent or guardian of a buckled child seat buckle when the vehicle is turned off.

To facilitate the use of the learning function or certain other functions of the portable controller device 50 that are more easily performed when the device is unplugged from the OBD-II port, an auxiliary battery 58 is optionally included in the circuitry to power the microcontroller 52 and other components when ‘off-OBD’.

Vehicle CAN Control

In another embodiment employing a CAN-controlling controller device, if the buckled status is ‘buckled’ and the status of the vehicle's ignition system is ‘off’, the microprocessor 52 initiates a ‘caution’ timing sequence, which can be pre-set or adjusted by the user using the updating port 64 or a menu-driven application of the portable controller device 50 via an interface, or can be selected by setting optional dual in-line package (DIP) switches on the portable controller device (not shown). The ‘caution’ timing sequence selects a caution time period or term sufficient in most normal situations and conditions for the user, such as a parent or guardian, after the engine has been turned off (and typically, the key removed from the ignition system), to egress from the vehicle and unbuckle the child restraint system that secures the child in the child safety seat. A parent or guardian who unbuckles a child from the child safety seat is presumed not to have forgotten that the child had been buckled into the child safety seat, and to have removed the child from the child seat during the ‘caution’ timing sequence. If during the caution timing sequence the buckled status changes to ‘unbuckled’ for a time period sufficient to evidence that the child safety latchplate has been disconnected from the buckle, the ‘caution sequence’ terminates. A time period that is “sufficient to evidence that the child safety latchplate has been disconnected from the buckle” is sufficiently longer than the ‘bounce’ time, which is a temporary or ‘bounce’ signal that may intermittently occur at the buckling detector if the buckle assembly is bounced or jostled in the ordinary course of use, even though the buckle remains latched, and which may be accommodated for by the use of a capacitor (not shown) or other software accommodation.

If the caution timing sequence is not terminated, but runs to an end time while the buckled status remains ‘buckled’, the microcontroller 52 will activate an alarm signal. The alarm signal initiates an alarm sequence, which alarm sequence remains ‘on’ until deactivated. In an aspect of the invention, the alarm sequence can be deactivated by unbuckling the latchplate 16 from the buckle 12, which transmits an ‘unbuckled’ signal, which is received by the portable controller device 50 and changes the buckled status to ‘unbuckled’. The alarm sequence can also be deactivated by an optional reset button or switch 60, which can be positioned on the outside of the housing 59 of the portable controller device 50. The alarm system can also be deactivated by cycling the ignition of the vehicle to the ‘on’ position, indicating the returned or continued presence of an adult parent or caretaker.

The alarm sequence can be preset to a default sequence, or can be programmed by the user using a computer or other data-entry device that interfaces with the portable controller device wirelessly or through the updating port 64, or by a menu-driven application of the portable controller device 50 via an interface (not shown), or by a ‘pause’ or ‘delay’ button or user selection switches (not shown) disposed on the housing 59 of the portable controller device 50. The alarm sequence can include one or a sequence of alarms, executed temporally in series or in parallel, employing an alarm that is integral with the portable controller device 50, or is one or more of the alarm signal-responding features of the vehicle utilizing the vehicle's CAN through the OBD-II port. The alarm signal-responding features of the passenger vehicle can include the automatic window opening and closing system, the automobile sound system or radio, the horn, the vehicle's lighting systems, including the compartment lights, headlight, warning lights, and taillights, a radio frequency (RF) signal, or telecommunication system, including a wireless network, a cellular network, and satellite network, such as On-Star™. The alarm sequence can escalate the severity or noticability of the alarm signal-responding feature to the general public or to authorities, depending upon the amount of time that has elapsed since the alarm sequence was initiated. For example, the alarm sequence may initially activate an audible voice that is generated by the portable controller device 50 and transmitted via an audio amplifier (not shown) through speaker 62, such as a simulated human voice stating “warning—child buckled in the child seat”. After the initial activation period of time, a second alarm may be activated, such as the vehicle's car horn. After the second activation period of time, a third alarm may be activated, such as the transmission of a 911 signal or an On-Star™ alert.

In an alternative embodiment of the portable ignition detection and controller device, the corresponding interface of the device for the OBD-II port can be connected to the housing of the device with a length of cable (not shown). The length of the cable can vary, depending on whether the user determines to attach the device to the underside of the dashboard, or to place the device in hand reach of the vehicle driver, which may require a longer cable length.

OEM Control and Transmission Reception

Nearly every vehicle manufactured today offers a Remote Keyless Entry (RKE) system as standard or optional equipment. These OEM systems operate in a 433 Mhz bandwidth, and includes an antenna, control processor, memory, and other components to accomplish keyless entry. The present invention also contemplates integrating the child seat safety system, including the restraint device, with an original equipment manufacturer (OEM) RKE system, thereby obviating the need for a separate portable OBD controller device for interfacing with the vehicle systems through the OBD-II port or an electrical system ports.

Such an integration with the OEM system requires that a logic branch be introduced into the software already present in the OEM system, allowing interpretation of messages received, or expected but not received, from the buckle status signal transmitter, and performing the logical functions handled by the separate hardware controller device. As the OEM controller system listens full-time for RKE messages, it is configured to also listen for a signal from the child seat's buckle status signal transmitter. The OEM controller system also has access to the same CAN network state messaging used the portable (OBD-II) controller device.

A vehicle manufacturer can produce vehicles ready to support the child seat safety device with no additional hardware cost per vehicle, and no after-market addition or modifications to the vehicle. The original manufacturing costs would be limited to the implementation costs of the controller software itself, believed to be negligible.

1. A child seat-vehicle safety system for a child safety seat in a passenger vehicle, comprising: a) at least one restraint device associated with a child safety seat, the restraint device including a restraint mechanism and a buckling detector that detects the buckling status of the restraint device as either buckled or unbuckled, and a buckle signal transmitter for transmitting a buckle status signal; b) a portable controller device that attaches to the On-Board Diagnostic II (OBD-II) port of the vehicle, including a means for detecting a parameter of the vehicle's ignition system, a transmission receiver for receiving the buckle status signal, and an alarm signal generator for generating an alarm signal in response to a predetermined condition of the ignition system parameter and the buckle status signal; and c) an optional alarm responsive to the alarm signal.

2. A method of warning a vehicle operator that a child has been left buckled in a child safety seat of a vehicle after the vehicle's ignition system has been turned off, the method including the steps of: providing a restraint device including a restraint mechanism; generating a buckle status signal in response to the buckling of the restraint mechanism; transmitting the buckle status signal; providing a portable controller device installed into the OBD-II port of the vehicle that detects the status of a parameter of the ignition system through the OBD-II port; detecting the status of the ignition system parameter; receiving the buckle status signal; and generating an alarm signal when the buckled status signal is ‘buckled’ and the status of the ignition system parameter changes from ‘on’ to ‘off’.

3.-7. (canceled)

8. A child seat-vehicle safety system for a child safety seat in a passenger vehicle, comprising: a) at least one restraint device associated with the child safety seat, the restraint device including a restraint mechanism and a buckling detector that detects the buckling status of the restraint device, and a buckle signal transmitter for transmitting an encrypted buckle status signal; and b) an on-board native controller device of a vehicle that includes a detector for detecting a parameter of the vehicle ignition system, a transmission receiver for receiving the buckle status signal, and an alarm signal generator for generating and transmitting an alarm signal to the vehicle CAN network system in response to a predetermined condition of the vehicle ignition system parameter and the buckle status signal.

9.-10. (canceled)

11. The child seat-vehicle safety system according to claim 1, wherein the restraint device is a restrain mechanism, including a chest restraint mechanism.

12. The child seat-vehicle safety system according to claim 11, wherein the restraint mechanism includes a latch member and a buckle member securable to the latch member.

13. The child seat-vehicle safety system according to claim 12, wherein the buckling detector is secured to either one of the buckle member or the latch member.

14. The child seat-vehicle safety system according to claim 1, wherein the buckling detector includes a detector switch, a replaceable battery, and a radio frequency (RF) transmitter.

15. The child seat-vehicle safety system according to claim 14, wherein the buckling detector is selected from the group consisting of a mechanical switch, an electro-mechanical switch, a magnetic switch, an optical switch, and a Hall effect switch.

16. The child seat-vehicle safety system according to claim 15, wherein the detector switch is a lever arm.

17. The child seat-vehicle safety system according to claim 15, wherein the detector switch is a single throw switch having a ‘buckled’ position and an ‘unbuckled’ position, or a single pole, double throw switch, having a default neutral position.

18. The child seat-vehicle safety system according to claim 1, wherein the buckle signal transmitter is an RF transmitter configured to transmit digitally a unique identification code assigned to the restraint device, and a ‘buckled’ or ‘unbuckled’ status signal.

19. The child seat-vehicle safety system according to claim 18, wherein the buckle status signal is a wireless signal.

20. The child seat-vehicle safety system according to claim 19, wherein the wireless signal is a radio frequency (RF) signal that contains at least the restraint device identification information.

21. The child seat-vehicle safety system according to claim 20, wherein the RF signal includes an encryption code, a unique identity (ID) code for the buckling detector, and a “buckled” and/or “unbuckled” signal code.

22. The child seat-vehicle safety system according to claim 21, wherein the RF signal further includes a battery voltage check code, an ambient temperature check code, and a CRC code.

23. The child seat-vehicle safety system according to claim 1, wherein the means for detecting a parameter of the vehicle's ignition system is selected from the group consisting of:
a) a portable controller device that interacts with the CAN network or other vehicle network to detect engine operation parameters or the vehicle ignition state;
b) a battery pin of the Data Link Connector (DLC) that electrically contacts a battery pin of the OBD-II port.

24. The child seat-vehicle safety system according to claim 1, wherein the portable controller device includes a microprocessor and non-volatile storage memory, on which can include a database of known vehicle manufacture information and an appropriate communication protocol for the passenger vehicle.

25. The child seat-vehicle safety system according to claim 24, wherein the alarm signal generator includes the alarm.

26. The child seat-vehicle safety system according to claim 24, wherein the portable controller device includes an interface for updating known vehicle manufacture information or software stored within the non-volatile memory.

27. The method according to claim 2, further including generating an alarm responsive to the alarm signal.
